(19) United States
(12) Patent Application Publication
(10) Pub. No.: US 2012/0280867 A1
(43) Pub. Date: Nov. 8, 2012

(54) INTERNAL ANTENNA MODULE

(75) Inventors: Hyungil Baek, Seoul (KR); Eulyoung Jung, Incheon (KR); Jinwon Noh, Incheon (KR); Sunghyun Kim, Gwacheon-si (KR); Miyeon Cho, Incheon (KR)

(73) Assignee: AMOTECH CO., LTD, Incheon (KR)

(21) Appl. No.: 13/262,233

(22) PCT Filed: Mar. 31, 2010
(86) PCT No.: PCT/KR2010/001979

§ 371 Date: Sep. 30, 2011

(30) Foreign Application Priority Data
Apr. 2, 2009 (KR) 10-2009-0028341
Apr. 8, 2009 (KR) 10-2009-0030229

(51) Int. Cl. H01Q 1/38

(52) U.S. Cl. 343/700 MS

(57) ABSTRACT

Disclosed herein is an internal antenna module that is installed in a terminal and that can receive signals in both the FM and Bluetooth frequency bands so as to achieve a small-sized, slim terminal. The internal antenna module includes a polyhedral chip antenna configured to have a first radiant pattern and a coupling pattern formed thereon, a flexible circuit board configured to have a first conductive pad connected to the first radiant pattern, a second conductive pad connected to a coupling pattern, and a second radiant pattern connected to the first radiant pattern, and a signal switching unit formed between the second conductive pad and a ground, and configured to prevent any one of a first frequency band signal and a second frequency band signal, received through the chip antenna and the flexible circuit board, from reaching the ground.

### TECHNICAL FIELD

The present invention relates generally to an internal antenna module and, more particularly, to an internal antenna module installed in a terminal.

### BACKGROUND ART

With the spread of mobile communication terminals, people can make phone calls and answer phone calls anytime and anywhere. Accordingly, there has been an innovative change in all aspects of real life. Furthermore, with an increase in the number of users who are always carrying a mobile communication terminal, various functions are added, which is helpful to real life. Among these various functions of the mobile communication terminal, parts related to multimedia are making rapid progress. Currently, mobile communication terminals which have added functions that are capable of generating and playing various multimedia files are being put on the market. That is, such a mobile communication terminal is no longer considered a device only for voice calls, but is considered an integrated handheld device having a variety of user convenience and entertainment functionality. A user can watch a movie, listen to music, and perform communication using one terminal, and can make a phone call when necessary. Accordingly, the time during which a user carries and uses the mobile communication terminal is gradually increasing.

Meanwhile, if a user wants to watch a movie or listen to music using a mobile communication terminal, the user has to download and watch the movie or listen to the music content one by one, which adds to the cost. In contrast, in the case of FM radio broadcasting, a user does not need to download individual pieces of new broadcasting content one by one in order to enjoy the content, and also may enjoy the content without any burden because additional costs are not incurred. For this reason, there is a need for a mobile communication terminal including an FM radio reception function.

However, an antenna for receiving FM radio must have a long radiation line because it must resonate at a low frequency band from about 87.5 to 108 MHz. Accordingly, the antenna inevitably has a large physical size. This makes it difficult to implement a small-sized internal antenna suitable for recent small-sized and slim mobile communication terminals (the physical size of the antenna increases in inverse proportion to the frequency (i.e., in proportion to the wavelength)).

In order to overcome the above problems, there is a case where the size of the antenna is reduced using a dielectric having a high dielectric constant However, when an internal antenna module for a low frequency band is implemented using the dielectric having a high dielectric constant, problems arise in that the manufacturing cost of the antenna increases and also the frequency bandwidth is narrowed in a low frequency band. Accordingly, an internal antenna module for a low frequency band having a desired radiation gain characteristic has not been implemented.

Furthermore, in order to overcome the above problems, there is a case where an earphone is used as an antenna for receiving FM radio based on the fact that most users listen to FM radio broadcasting using an earphone. In this case, if the earphone (i.e., a headset or an ear microphone) is removed, a fatal problem arises in that FM radio reception efficiency is very poor. For example, if an FM radio broadcast is output through a speaker contained in a terminal or if an external speaker is connected to an earphone jack (in this case, the connection part plays the role of an antenna for an FM receiver, but the length of the connection part is not suitable and the connection part may interfere with an amplification unit or the like), FM radio may not normally be heard because the FM reception performance is very low. Furthermore, the recent mobile communication terminal having a Bluetooth function is problematic in that it does not adopt a method using the line of a radio earphone as an antenna through the earphone jack because it receives a voice signal output from the terminal through the earphone. Furthermore, a mobile communication terminal that lacks the Bluetooth function is disadvantageous in that the earphone should be connected to the terminal in order to receive FM radio broadcasts.

For the above reason, there is a need for an internal antenna module for a low frequency band that is applied to a mobile communication terminal, that can achieve a small-sized and slim mobile communication terminal and that enables FM radio reception at high-level Received Signal Strength Indication (RSSI).

Furthermore, the recent use of Bluetooth devices is increasing. Accordingly, a separate Bluetooth antenna for receiving signals in the Bluetooth frequency band for communication with the Bluetooth device is mounted on a mobile communication terminal. In this case, it is difficult to achieve recent small-sized and slim mobile communication terminals, which is the recent trend, because both an internal antenna module for a low frequency band and a Bluetooth antenna module must be installed.

In light of the above problems, there is a need for an internal antenna module that is applied to a mobile communication terminal and that can receive signals in both the FM and Bluetooth frequency bands.

### DISCLOSURE

### Technical Problem

The present invention has been made keeping in mind the above problems occurring in the prior art, and an object of the present invention is to provide an internal antenna module that is installed in a terminal and that can receive signals in both the FM and Bluetooth frequency bands so as to achieve a small-sized, slim terminal.

### Technical Solution

In order to accomplish the above object, the present invention provides an internal antenna module, including a polyhedral chip antenna configured to have a first radiant pattern and a coupling pattern formed thereon; a flexible circuit board configured to have a first conductive pad connected to the first radiant pattern, a second conductive pad connected to the coupling pattern, and a second radiant pattern connected to the first radiant pattern; and a signal switching unit formed between the second conductive pad and a ground, and configured to prevent any one of a first frequency band signal and a second frequency band signal, received through the chip antenna and the flexible circuit board, from reaching the ground.

The second radiant pattern may be configured in a meander line form.

The signal switching unit may prevent the second frequency band signal from reaching the ground and send the second frequency band signal to a Bluetooth signal processing module.

The signal switching unit may be formed of an inductor that prevents a Bluetooth frequency band signal from reaching the ground.

The second frequency band signal may be a Bluetooth frequency band signal.

The first frequency band signal may be an FM frequency band signal.

The internal antenna module may further include a filter unit for removing a high frequency component from the first frequency band signal.

The internal antenna module further includes a Low Noise Amplifier (LNA) for amplifying a reception signal from which the high frequency component has been removed by the filter unit.

The internal antenna module may further include a matching capacitor formed between the second conductive pad and the second radiant pattern and configured to correct a difference in impedance between the second conductive pad and a circuit mounted on a substrate on which the flexible circuit board is mounted.

The internal antenna module may further include a matching inductor formed on the second conductive pad and configured to correct a difference in impedance between the second conductive pad and a circuit mounted on a substrate on which the flexible circuit board is mounted.

In order to accomplish the above object, the present invention provides an internal antenna module, including a polyhedral chip antenna configured to have a first radiant pattern and a coupling pattern formed therein; a flexible circuit board configured to have a first conductive pad connected to the first radiant pattern, a second conductive pad connected to the coupling pattern, and a second radiant pattern connected to the first radiant pattern; and a signal branch unit configured to branch a first frequency band signal and a second frequency band signal received through the chip antenna and the flexible circuit board.

The signal branch unit separates the first frequency band signal off into an FM signal processing module and the second frequency band signal off into a Bluetooth signal processing module.

The internal antenna module may further include an LNA for amplifying the first frequency band signal separated off by the signal branch unit

The first frequency band signal may be an FM frequency band, signal and the second frequency band signal may be a Bluetooth frequency band signal.

The signal branch unit is formed of a diplexer for separating an FM frequency band signal off into an FM signal processing module and a Bluetooth frequency band signal off into a Bluetooth signal processing module.

In order to accomplish the above object, the present invention provides an internal antenna module, including a polyhedral chip antenna configured to have a first radiant pattern and a coupling pattern formed therein; a flexible circuit board configured to have a first conductive pad connected to the first radiant pattern, a second conductive pad connected to the coupling pattern, and a second radiant pattern connected to the first radiant pattern; and a third radiant pattern formed adjacent to the second radiant pattern on the flexible circuit board.

The third radiant pattern may be electrically connected to a Bluetooth signal processing module.

The internal antenna module may further include a fourth radiant pattern formed adjacent to the third radiant pattern on the flexible circuit board, and the fourth radiant pattern may be electrically connected to a GPS signal processing module.

The third radiant pattern may be electrically connected to a GPS signal processing module.

The internal antenna module may further include a fourth radiant pattern formed adjacent to the third radiant pattern on the flexible circuit board, and the fourth radiant pattern may be electrically connected to a Bluetooth signal processing module.

In order to accomplish the above object, the present invention provides an internal antenna module, including a chip antenna of a polyhedral block on which a first radiant pattern and a coupling pattern are formed; and a flexible circuit board in which a first conductive pad connected to the first radiant pattern, a second conductive pad connected to the coupling pattern, and a second radiant pattern connected to the first radiant pattern are formed; wherein the first conductive pad is electrically connected to an FM signal processing module and a Bluetooth signal processing module, and sends reception signals, received through the chip antenna and the flexible circuit board, to the FM signal processing module and the Bluetooth signal processing module.

The internal antenna module may further include a filter unit for removing a high frequency component from the reception signal sent to the FM signal processing module.

The internal antenna module may further include an LNA for amplifying the reception signal from which the high frequency component has been removed by the filter unit

In order to accomplish the above object, the present invention provides an internal antenna module, including a polyhedral chip antenna on which a first radiant pattern and a coupling pattern are formed; and a flexible circuit board in which a first conductive pad connected to the first radiant pattern, a second conductive pad connected to a coupling pattern of the chip antenna, and a second radiant pattern adjacent to the second conductive pad are formed; wherein the flexible circuit board further comprises a switching element formed between the second radiant pattern and the first radiant pattern and prevents any one of a first frequency band signal and a second frequency band signal, received through the second radiant pattern, from reaching the first radiant pattern.

The switching element may block the second frequency band signal received through the second radiant pattern and sends the second frequency band signal to a Bluetooth signal processing module.

The second frequency band signal may be a Bluetooth frequency band signal.

The switching element may be formed of an inductor for preventing a Bluetooth frequency band signal from reaching the first radiant pattern.

### Advantageous Effects

The internal antenna module according to the present invention does not require a separate Bluetooth antenna because it receives signals at FM and Bluetooth frequencies at the same time. Accordingly, it is possible to apply the internal antenna module to a mobile communication terminal and make the mobile communication terminal small and slim.

Furthermore, the internal antenna module according to the present invention can receive FM radio at a high RSSI level.

Furthermore, spatial utilization can be increased because the spatial burden is reduced when the internal antenna module according to the present invention is mounted on a main printed circuit board. Accordingly, the degree of freedom for a structure in which parts are installed within a terminal can be improved.

Furthermore, the internal antenna module according to the present invention has a simple construction because it does not require additional means, such as an earphone for receiving FM radio. Accordingly, in the case of a Bluetooth mobile communication terminal, constant reception quality can be maintained without any reduction in the FM radio broadcasting reception ratio although a radio earphone is used.

### DESCRIPTION OF DRAWINGS

FIG. 1 is a perspective view illustrating a chip antenna applied to an internal antenna module according to an embodiment of the present invention;

FIG. 2 is an exploded view illustrating the structure of the radiant and coupling patterns of the chip antenna shown in FIG. 1;

FIGS. 3(a) to 3(c) are plan views illustrating the structure of a flexible circuit board connected to the chip antenna of FIG. 1;

FIG. 4 is a plan view illustrating the state in which the chip antenna of FIG. 1 is mounted on the flexible circuit board shown in FIGS. 3(a) to 3(c);

FIG. 5 is a diagram illustrating an internal antenna module according to a first embodiment of the present invention;

FIGS. 6 and 7 are diagrams illustrating a signal switching unit of FIG. 5;

FIGS. 8 to 10 are diagrams illustrating the filter unit and Low Noise Amplifier (LNA) of FIG. 5;

FIG. 11 is a graph showing the frequency bands of the internal antenna module according to the first embodiment of the present invention;

FIG. 12 is a diagram illustrating an internal antenna module according to a second embodiment of the present invention;

FIG. 13 is a diagram illustrating an internal antenna module according to a third embodiment of the present invention;

FIG. 14 is a diagram illustrating an internal antenna module according to a fourth embodiment of the present invention;

FIGS. 15(a) to 15(c) are plan views illustrating the structure of a flexible circuit board electrically connected to the chip antenna of FIG. 1;

FIG. 16 is a plan view illustrating the state in which the chip antenna of FIG. 1 is mounted on the flexible circuit board shown in FIGS. 15(a) to 15(c);

FIGS. 17 and 18 are diagrams illustrating a signal switching unit of FIG. 16;

FIGS. 19 to 21 are diagrams illustrating a filter unit and an LNA of FIG. 16;

FIG. 22 is a graph showing the frequency bands of the internal antenna module according to the fourth embodiment of the present invention;

FIGS. 23 and 24 are diagrams illustrating an internal antenna module according to a fifth embodiment of the present invention;

FIGS. 25 and 26 are diagrams illustrating an internal antenna module according to a modified example of the fifth embodiment of the present invention;

FIGS. 27 and 28 are diagrams illustrating an internal antenna module according to a sixth embodiment of the present invention;

FIGS. 29 and 30 are diagrams illustrating an internal antenna module according to a modified example of the sixth embodiment of the present invention;

FIGS. 31 and 32 are diagrams illustrating an internal antenna module according to a seventh embodiment of the present invention; and

FIG. 33 is a graph showing the frequency bands of the internal antenna module according to the seventh embodiment of the present invention.

### BEST MODE

Some embodiments of the present invention will now be described in detail with reference to the accompanying drawings in order for a person having ordinary skill in the art to be able to easily implement the technical spirit of the present invention. It should be noted that in assigning reference numerals to respective elements in the drawings, the same reference numerals designate the same elements although the elements are shown in different drawings. Furthermore, in describing the present invention, detailed descriptions of the known functions and constructions will be omitted if they are deemed to make the gist of the present invention unnecessarily vague. The embodiments of the present invention are provided in order to fully describe the present invention to a person having ordinary skill in the art. Accordingly, the shapes, sizes, etc. of the elements in the drawings may be exaggerated for the sake of a clear description.

Hereinafter, a chip antenna and a flexible circuit board which are applied in common to the embodiments of the present invention will be described with reference to the accompanying drawings

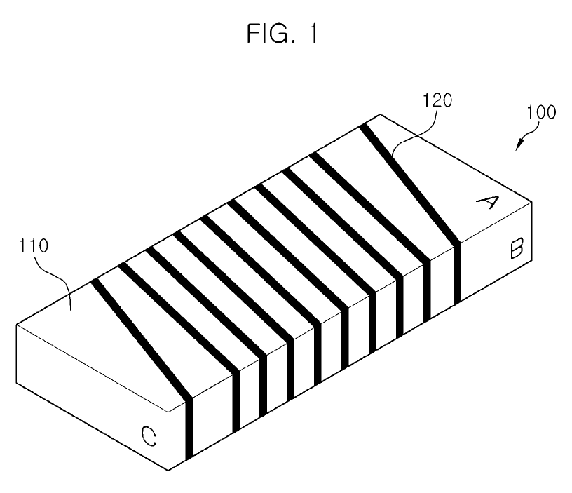

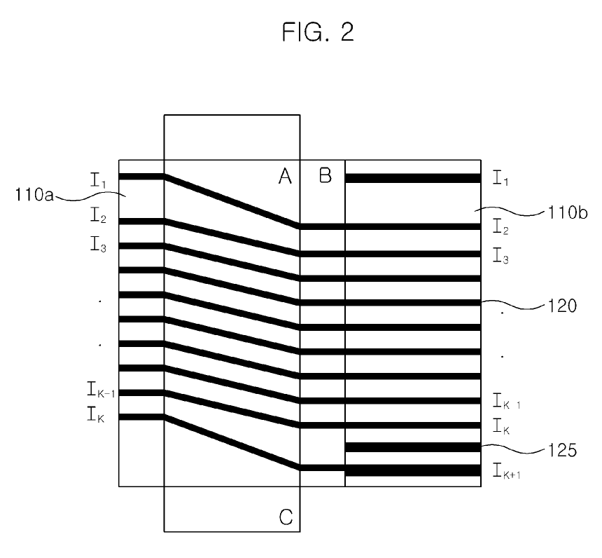

FIG. 1 is a perspective view illustrating a chip antenna applied to an internal antenna module according to an embodiment of the present invention, and FIG. 2 is an exploded view illustrating the structure of the radiant and coupling patterns of the chip antenna shown in FIG. 1.

The chip antenna 100 includes a polyhedral block 110 made of a magneto-dielectric, a first radiant pattern 120 configured in a winding form along the external faces of the polyhedral block 110, and a coupling pattern 125 spaced apart from the first radiant pattern 120 at specific intervals.

The polyhedral block 110 may be made of a magneto-dielectric. The magneto-dielectric refers to a magnetic material, including iron oxide, chrome oxide, cobalt, ferrite, etc.

$$BW = \frac{96 \sqrt{\frac{{μ}_{0}}{{ɛ}_{r}}} \frac{t}{{λ}_{0}}}{\sqrt{2} [ 4 + 17 \sqrt{{μ}_{r} {ɛ}_{r}} ]} \qquad ( 1 )$$

Equation 1 is an equation indicating that the bandwidth BW of an antenna increases with an increase in the ratio of the magnetic permeability to the dielectric constant when the size of the antenna remains unchanged. Here, λ₀ is the wavelength, μᵣ is the magnetic permeability, εᵣ is the dielectric constant, and t is the thickness of the antenna. In general, a dielectric with a high dielectric constant that is applied to an antenna has a magnetic permeability lower than the dielectric constant. However, if a magneto-dielectric having a magnetic permeability greater than the dielectric constant (the magneto-dielectric applied to an embodiment of the present invention has a magnetic permeability of about 18 and a dielectric constant of about 10) is used, a wider bandwidth can be implemented than with a dielectric having a high dielectric constant for the same antenna size according to Equation 1. Accordingly, if an antenna for a low frequency band is implemented using a dielectric block having a high dielectric constant in order to reduce the size of the antenna, the phenomenon of narrowing the bandwidth can be overcome using a magneto-dielectric having a low dielectric constant and magnetic permeability, thereby being capable of maintaining the bandwidth but reducing the size of the antenna. Meanwhile, the polyhedral block 110 applied to the present invention may be selected depending on a desired resonant frequency because it has the different magnetic permeability and dielectric constant. Furthermore, the size and shape of the polyhedral block 110 may vary depending on the desired frequency band.

The first radiant pattern and the coupling pattern formed on the polyhedral block will be described below with reference to FIG. 2. In order to further understanding of the present invention, conductor patterns formed on the polyhedral block 110 are called the first radiant pattern 120, and conductor patterns formed on a flexible circuit board 200 according to an embodiment of the present invention to be described later are called second radiant patterns 230.

The first radiant pattern 120 I₁ to Iₖ formed on one side face 110a of the polyhedral block 110 are connected to the first radiant pattern 120 I₁ to Iₖ formed on the bottom 110b of the polyhedral block 110, respectively. In FIG. 2, the first radiant pattern 120 I₁ to Iₖ formed on the one side face 110a are illustrated as seeming to be different from the first radiant pattern 120 I₁ to Iₖ formed on the bottom 110b. If FIG. 2 is implemented in the state of FIG. 1, the first radiant pattern 120 starts from one side of the bottom 110b of the polyhedral block 110 and form a winding form along the external faces of the polyhedral block 110, thereby forming radiation lines. The length and line width of the first radiant pattern 120 and the interval there between may vary depending on the desired resonant frequency.

The coupling pattern 125 is formed on the bottom 110b of the polyhedral block 110, and is spaced apart from the first radiant pattern 120 at specific intervals. The coupling pattern 125 couples the flow of current introduced into the first radiant pattern 120, thereby increasing the bandwidth of the antenna. In an embodiment of the present invention, the one coupling pattern 125 is formed on the bottom 110b of the polyhedral block 110 so that the coupling pattern 125 resonates in an FM radio frequency band (87.5 to 108 MHz). FIG. 2 shows only the one coupling pattern 125, but is not limited thereto. The number of coupling patterns 125 generating coupling may vary depending on the desired frequency band and bandwidth. A desired resonant frequency and bandwidth may be controlled by increasing or decreasing the number of coupling patterns 125.

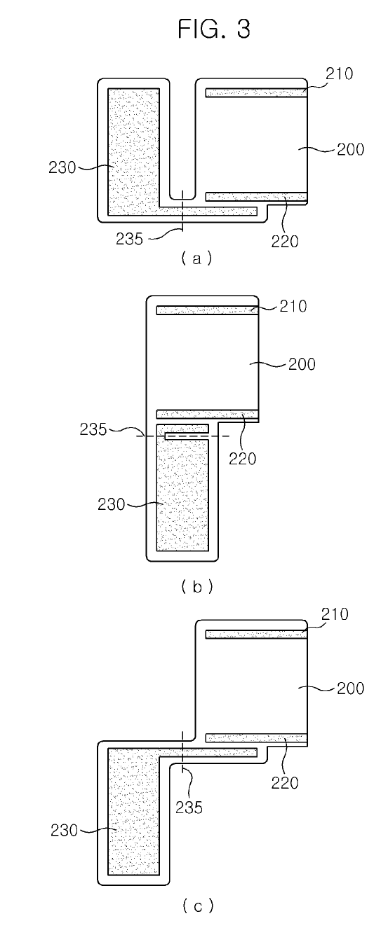

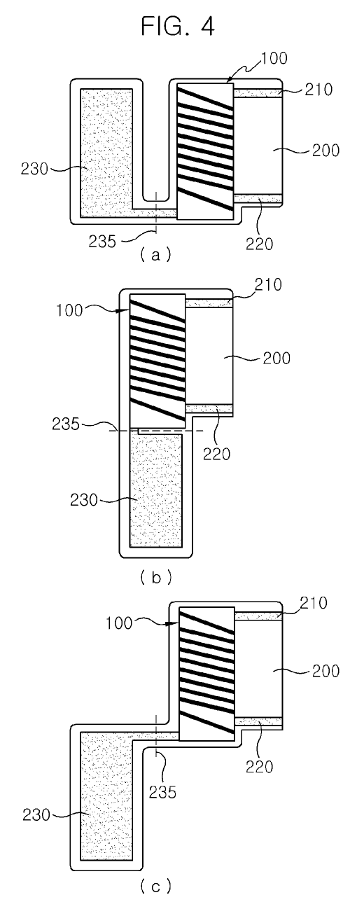

FIGS. 3(a) to 3(c) are plan views illustrating the structure of the flexible circuit board 200 connected to the chip antenna 100 of FIG. 1, and FIG. 4 is a plan view illustrating the state in which the chip antenna of FIG. 1 is mounted on the flexible circuit board shown in FIGS. 3(a) to 3(c).

First, the structure of the flexible circuit board 200 applied to the present invention will now be described with reference to FIGS. 3(a) to 3(c).

The chip antenna 100 is mounted on any one face (e.g., the top surface of the flexible circuit board 200) of the flexible circuit board 200.

The flexible circuit board 200 includes a first conductive pad 210, a second conductive pad 220, and a second radiant pattern 230.

The first conductive pad 210 is used as a feeding pad. The first conductive pad 210 is soldered and electrically connected to the first radiant pattern 120 I₁ formed at the end of one side of the bottom 110b of the polyhedral block 110.

The second conductive pad 220 is used as a ground pad. The second conductive pad 220 is soldered and electrically connected to the coupling pattern 125 formed on the bottom 110b of the polyhedral block 110.

The second radiant pattern 230 is soldered and electrically connected to the first radiant pattern 120 Iₖ₊₁ formed at the end of the other side of the bottom 110b of the polyhedral block 110. For this purpose, the second radiant pattern 230 includes a connection part connected to the first radiant pattern 120 Iₖ₊₁ and a radiation part configured to extend from the connection part and formed outside an area on which the polyhedral block 110 is mounted on the flexible circuit board 200. Here, the connection part and the radiation part may be distinguished from each other on the basis of a bent part 235 shown in FIG. 3. That is, a part soldered to the first radiant pattern 120 Iₖ₊₁ corresponds to the connection part, and a part configured to extend from the connection part and formed outside the area on which the polyhedral block 110 is mounted on the flexible circuit board 200 corresponds to the radiation part, on the basis of the bent part 235 in the second radiant pattern 230. This is applied to the drawings which will be described later.

When the second radiant pattern 230 is electrically connected to the first radiant pattern 120 Iₖ₊₁ formed at the end of the other side of the bottom 110b of the polyhedral block 110, the first radiant pattern 120 and the second radiant pattern 230 formed on the flexible circuit board 200 form one radiation line (refer to FIG. 4).

### First Embodiment

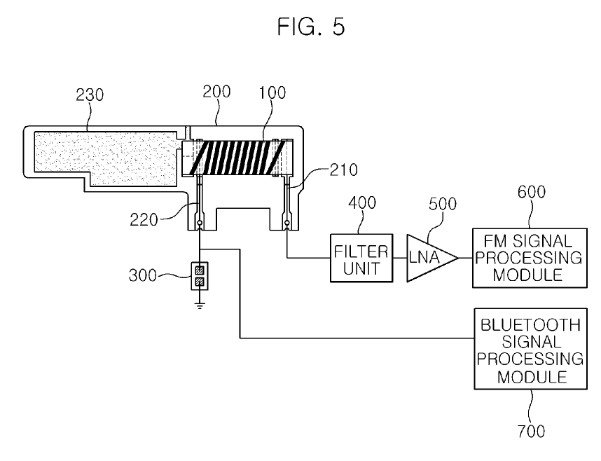

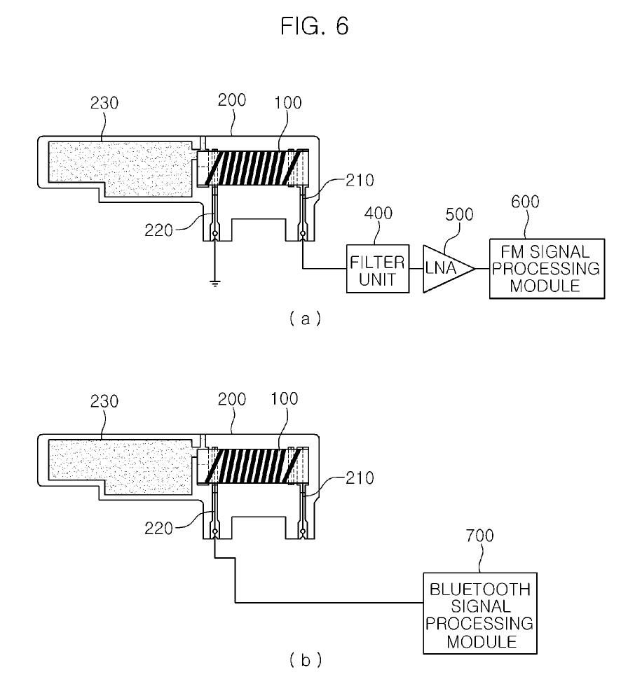

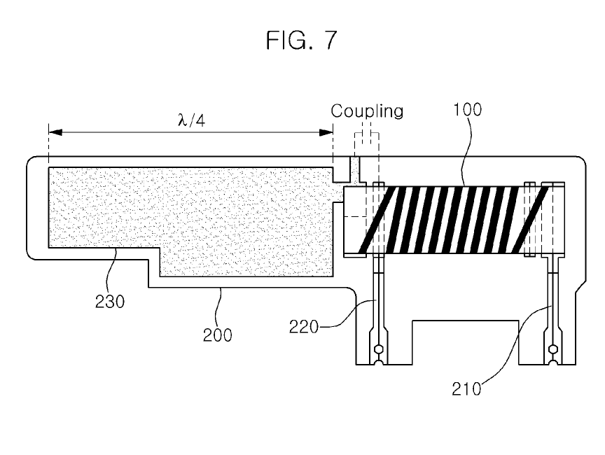

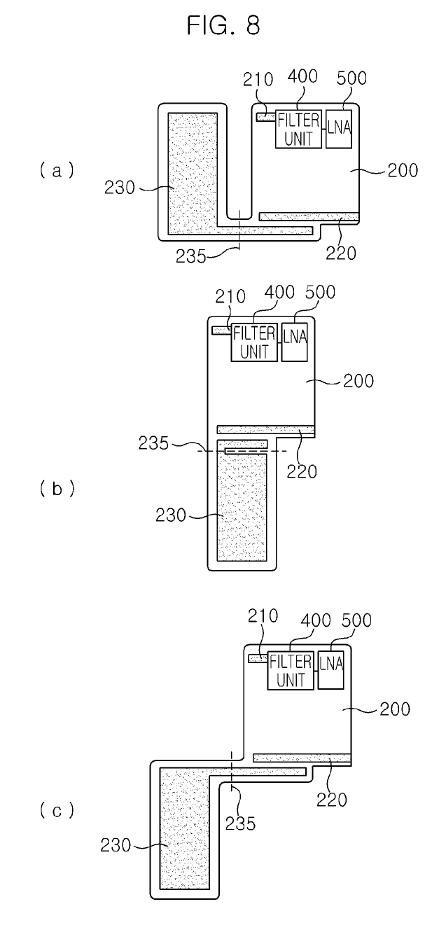

Hereinafter, an internal antenna module according to a first embodiment of the present invention will be described in detail with reference to the accompanying drawings. FIG. 5 is a diagram illustrating the internal antenna module according to the first embodiment of the present invention. FIGS. 6 and 7 are diagrams illustrating the signal switching unit of FIG. 5. FIGS. 8 to 10 are diagrams illustrating the filter unit and Low Noise Amplifier (LNA) of FIG. 5. First, since the chip antenna and flexible circuit board of the internal antenna module according to the first embodiment of the present invention are the same as the chip antenna and the flexible circuit board described with reference to FIGS. 1 to 4, descriptions thereof will be omitted here and the same reference numerals are used. Furthermore, since an FM signal processing module and a Bluetooth signal processing module may be easily implemented by a person having ordinary skill in the art using the known art, detailed descriptions thereof will be omitted here.

As shown in FIG. 5, the internal antenna module includes the chip antenna 100, the flexible circuit board 200, a signal switching unit 300, the filter unit 400, and the LNA 500.

One side of the signal switching unit 300 is connected to the second conductive pad 220, and the other side thereof is connected to a ground GND. That is, one side of the signal switching unit 300 is soldered and electrically connected to the second conductive pad 220 of the flexible circuit board 200, and the other side thereof is soldered and electrically connected to the ground GND. Here, the signal switching unit 300 is formed of an inductor that transmits a reception signal in an FM frequency band and blocks a reception signal in the Bluetooth frequency band. The purpose of this is to separate the reception signal in an FM frequency band and the reception signal in the Bluetooth frequency band using the characteristics of the inductor which has an impedance that increases when a passing frequency increases and thus operates as a Low Pass Filter (LPF) and has an impedance that falls when a passing frequency falls and thus operates as a High Pass Filter (HPF). Here, the inductor used as the signal switching unit 300 has about 22 nH that transmits the reception signal in an FM frequency band (about 87.5 to 108 MHz) and blocks the reception signal in the Bluetooth frequency band (about 2.45 GHz).

The signal switching unit 300 severs the connection with the ground GND depending on the frequency of a reception signal received via the chip antenna 100 and the flexible circuit board 200. Here, the signal switching unit 300 maintains the connection with the ground GND when the frequency of the reception signal is a low frequency signal, and severs the connection with the ground GND in order to send the reception signal to a Bluetooth signal processing module 700 when the frequency of the reception signal is a high frequency signal. That is, when the reception signal in an FM frequency band (i.e., a low frequency) is received, the signal switching unit 300 plays the role of a line to maintain the connection with the ground GND. When the reception signal in the Bluetooth frequency band (i.e., at a high frequency) is received, the signal switching unit 300 severs the connection with the ground GND so that the reception signal is prevented from being sent to the ground GND.

The signal switching unit 300 formed of the inductor having 22 nH will now be described in more detail. When the reception signal in an FM frequency band (i.e., at a low frequency) is received through the chip antenna 100 and the flexible circuit board 200, the inductor maintains the connection part and the ground GND in a connected state and thus plays the role of a line that transmits the reception signal to the ground GND. Accordingly, the second conductive pad 220 plays the role of ground, and the internal antenna module operates, as shown in FIG. 6(a).

When the reception signal in the Bluetooth frequency band (i.e., at a high frequency) is received through the chip antenna 100 and the flexible circuit board 200, the inductor is opened so that the reception signal is prevented from being sent to the ground GND. Accordingly, the internal antenna module operates as a circuit, not including the inductor and the ground GND, as shown in FIG. 6(b), and thus operates as a monopole antenna. That is, as shown in FIG. 7, coupling is generated because the second conductive pad 220 is spaced apart from the radiation part of the second radiant pattern 230 at a specific interval. The radiation part plays the role of a λ/4 resonant line in the Bluetooth frequency band, and operates as a Bluetooth antenna.

Meanwhile, the reception signal in the Bluetooth frequency band blocked by the signal switching unit 300 is input to the Bluetooth signal processing module 700.

The filter unit 400 is provided on the flexible circuit board 200. One side of the filter unit 400 is electrically connected to the first radiant pattern 120 formed on the polyhedral block 110 via the first conductive pad 210, and the other side of the filter unit 400 is electrically connected to the LNA 500. The filter unit 400 removes a high frequency component from the reception signal received via the chip antenna 100 and the flexible circuit board 200. In the case of Bluetooth, a transmission signal in the Bluetooth frequency band is periodically generated from a terminal and a Bluetooth device for communication between the terminal and the Bluetooth device. Accordingly, the reception signal in an FM frequency band may interfere with the transmission signal in the Bluetooth frequency band. The filter unit 400 removes a high frequency component in order to prevent signal interference from being generated in the reception signal due to the transmission signal in a Bluetooth frequency band.

The LNA 500 is provided on the flexible circuit board 200, and is electrically connected to the filter unit 400. The LNA 500 amplifies the reception signal from which the high frequency component has been removed by the filter unit 400 (i.e., the reception signal in an FM frequency band from which signal interference due to the transmission signal in the Bluetooth frequency band has been removed), thereby enabling FM radio to be received at a high RSSI level. The LNA 500 is designed by setting an operating point and a matching point so that the reception signal has a low Noise Factor (NF). The reception signal amplified by the LNA 500 is input to an FM signal processing module 600.

Since the LNA 500 applied to the present invention is a technical element which may be easily implemented by a person having ordinary skill in the art using the known art, a detailed description thereof will be omitted here.

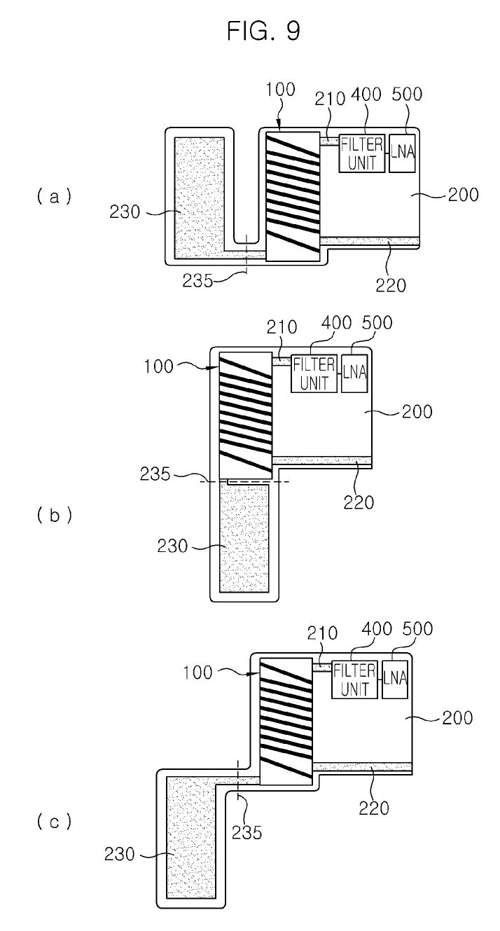

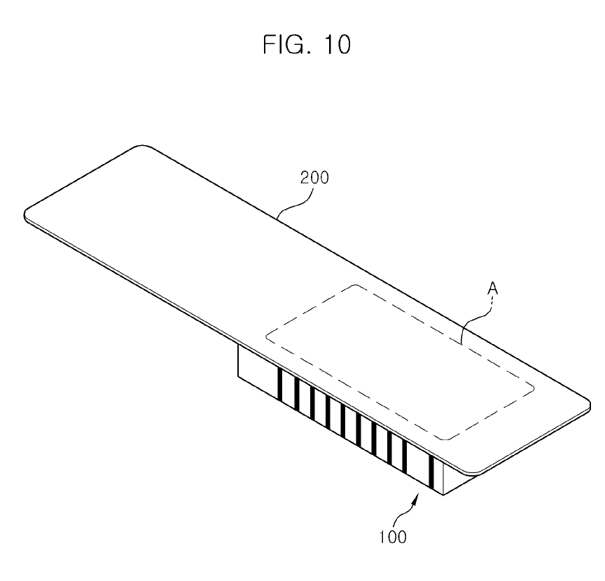

Meanwhile, if the filter unit 400 and the LNA 500 are included in the flexible circuit board 200, they may be included in separate areas on the same plane as the chip antenna 100 as shown in FIGS. 8 and 9, or may be included on the other face (i.e., an area ‘A’ of FIG. 10) opposite to one face on the flexible circuit board 200 on which the chip antenna 100 is mounted, as shown in FIG. 10. The filter unit 400 and the LNA 500 may be included on different faces. In this case, spatial utilization can be increased because the spatial requirements can be reduced when the internal antenna module according to the present invention is subsequently mounted on a main printed circuit board (not shown). Accordingly, the degree of freedom for a structure in which parts are installed within a terminal can be improved.

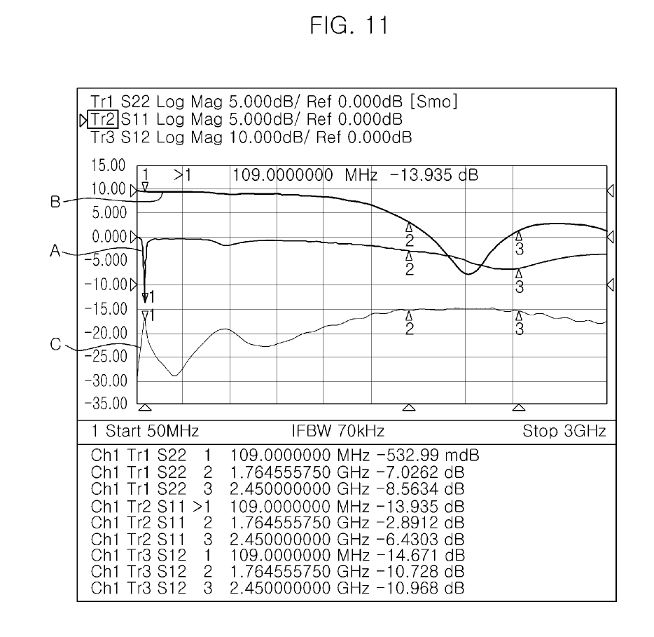

FIG. 11 is a graph showing the frequency bands of the internal antenna module according to the first embodiment of the present invention.

FIG. 11 is a graph showing the frequencies of reception signals received via the first conductive pad 210 and the second conductive pad 220 and the signal interference between the reception signals, when the internal antenna module according to the first embodiment of the present invention is used. In this graph, “A” indicates the frequency of the reception signal received via the first conductive pad 210, and “B” is the frequency of the reception signal received via the second conductive pad 220. Furthermore, “C” is the amount of the reception signal that is received via the second conductive pad 220 and then goes over to the first conductive pad 210 (i.e., the amount of signal interference).

The frequency of the reception signal (i.e., “A” in FIG. 11) received via the first conductive pad 210 shows that it has a resonant frequency band of about 87.5 MHz to 108 MHz. That is, the radiation part formed on the flexible circuit board 200 and the first radiant pattern 120 formed on the chip antenna 100 form one radiation line, so that the reception signal in a low frequency band (i.e., an FM frequency band from 87.5 MHz to 108 MHz) is received.

Furthermore, the frequency of the reception signal (i.e., “B” in FIG. 11) received via the second conductive pad 220 shows that it has a resonant frequency band of about 2.4 GHz. That is, the second conductive pad 220 is spaced apart from the radiation part, so that coupling is generated. The radiation part plays the role of a λ/4 resonant line in the Bluetooth frequency band. Accordingly, the internal antenna module operates as a monopole antenna using coupling, and thus receives a reception signal having the frequencies of a Bluetooth frequency band.

Here, from the amount of signal interference (i.e., “C” in FIG. 11), it can be seen that signal interference of the reception signal received via the second conductive pad 220 with the reception signal received via the first conductive pad 210 is weak

### Second Embodiment

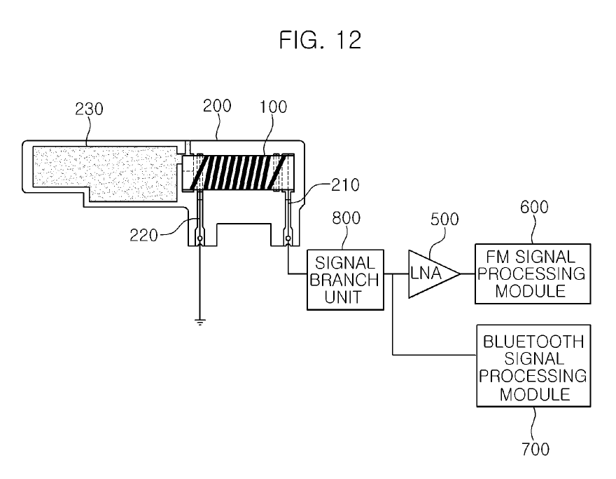

Hereinafter, an internal antenna module according to a second embodiment of the present invention will be described in detail with reference to the accompanying drawing. FIG. 12 is a diagram illustrating the internal antenna module according to the second embodiment of the present invention.

First, since the chip antenna and flexible circuit board of the internal antenna module according to the second embodiment of the present invention are the same as the chip antenna and the flexible circuit board described with reference to FIGS. 1 to 4, descriptions thereof will be omitted here and the same reference numerals are used. Furthermore, since an FM signal processing module and a Bluetooth signal processing module may be easily implemented by a person having ordinary skill in the art using the known art, detailed descriptions thereof will be omitted here.

As shown in FIG. 12, the internal antenna module includes a chip antenna 100, a flexible circuit board 200, a signal branch unit 800, and an LNA 500.

One side of the signal branch unit 800 is electrically connected to the first conductive pad 210 of the flexible circuit board 200, and the other side thereof is electrically connected to the LNA 500 and a Bluetooth signal processing module 700. Here, the signal branch unit 800 is formed of a diplexer for branching a reception signal, received via the chip antenna 100 and the flexible circuit board 200, based on the frequencies of the reception signal. The diplexer includes an LPF and an HPF, and separates reception signals of a low frequency and a high frequency off into different paths based on the frequencies of the reception signals.

The signal branch unit 800 branches a reception signal, received via the chip antenna 100 and the flexible circuit board 200, based on the frequencies of the reception signal. That is, the signal branch unit 800 branches a reception signal to an FM signal processing module 600 via the LNA 500 or to the Bluetooth signal processing module 700 based on the frequencies of the reception signal. Here, the signal branch unit 800 branches the reception signal in an FM frequency band (i.e., a low frequency), received via the chip antenna 100 and the flexible circuit board 200, to the FM signal processing module 600, and branches the reception signal in the Bluetooth frequency band (i.e., at a high frequency), received via the chip antenna 100 and the flexible circuit board 200, to the Bluetooth signal processing module 700.

The LNA 500 is provided on the flexible circuit board 200, and is electrically connected to the signal branch unit 800. The LNA 500 amplifies the reception signal of a low frequency (i.e., the reception signal in an FM frequency band) branched by the signal branch unit 800, thereby enabling FM radio to be received at a high RSSI level. The LNA 500 is designed by setting an operating point and a matching point so that the reception signal has a low NF. The reception signal amplified by the LNA 500 is input to the FM signal processing module 600.

Since the LNA 500 applied to the present invention is a technical element that may be implemented by a person having ordinary skill in the art using the known art, a detailed description thereof will be omitted here.

### Third Embodiment

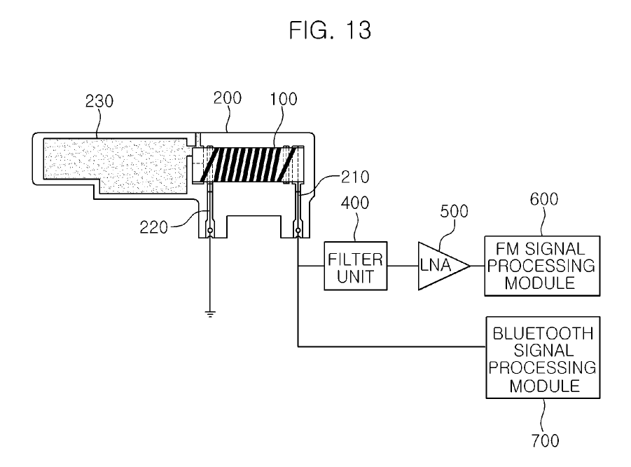

Hereinafter, an internal antenna module according to a third embodiment of the present invention will be described in detail with reference to the accompanying drawing. FIG. 13 is a diagram illustrating the internal antenna module according to the third embodiment of the present invention. First, since the chip antenna and flexible circuit board of the internal antenna module according to the third embodiment of the present invention are the same as the chip antenna and the flexible circuit board described with reference to FIGS. 1 to 4, descriptions thereof will be omitted here and the same reference numerals are used. Furthermore, an FM signal processing module and a Bluetooth signal processing module are technical elements that may be easily implemented by a person having ordinary skill in the art using the known art, and a detailed description thereof will be omitted here.

As shown in FIG. 13, the internal antenna module includes a chip antenna 100, a flexible circuit board 200, a filter unit 400, and an LNA 500.

The first conductive pad 210 of the flexible circuit board 200 is electrically connected to the filter unit 400 and a Bluetooth signal processing module 700. Here, a reception signal received via the chip antenna 100 and the flexible circuit board 200 is input to the filter unit 400 and the Bluetooth signal processing module 700 at the same time.

The filter unit 400 is provided on the flexible circuit board 200. One side of the filter unit 400 is electrically connected to the first radiant pattern 120 formed on the polyhedral block 110 via the first conductive pad 210, and the other side thereof is electrically connected to the LNA 500. The filter unit 400 blocks a reception signal which belongs to reception signals received via the chip antenna 100 and the flexible circuit board 200 and corresponds to a Bluetooth frequency band, transmits a reception signal which belongs to reception signals and corresponds to an FM frequency band, and inputs the reception signal corresponding to an FM frequency band to the LNA 500.

The filter unit 400 removes a high frequency component in order to prevent signal interference generated in a reception signal due to a transmission signal in the Bluetooth frequency band. Since this is the same as the filter unit 400 of the first embodiment, a detailed description thereof will be omitted here.

The LNA 500 is provided on the flexible circuit board 200, and is electrically connected to the filter unit 400. The LNA 500 amplifies a reception signal from which the high frequency component has been removed by the filter unit 400 (i.e., a reception signal in an FM frequency band from which signal interference due to a transmission signal in the Bluetooth frequency band and a reception signal in the Bluetooth frequency band have been removed), thereby enabling FM radio to be received at a high RSSI level. The LNA 500 is designed by setting an operating point and a matching point so that the reception signal has a low NF. The reception signal amplified by the LNA 500 is input to the FM signal processing module 600.

Since the LNA 500 applied to the present invention is a technical element that may be implemented by a person having ordinary skill in the art using the known art, a detailed description thereof will be omitted here.

### Fourth Embodiment

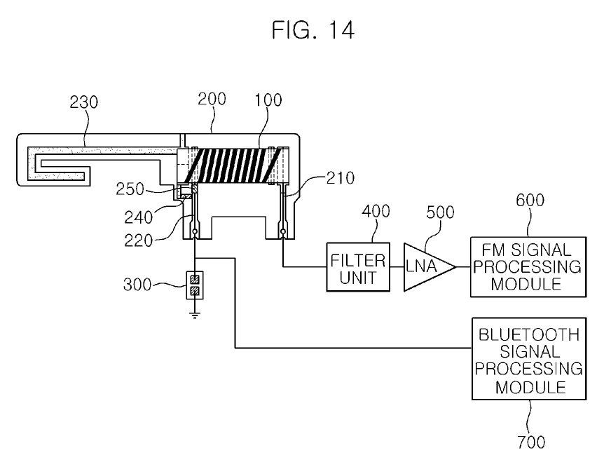

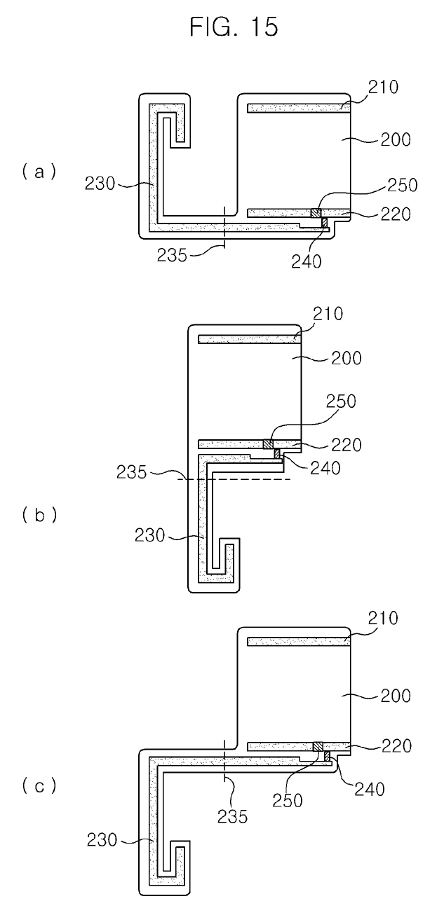

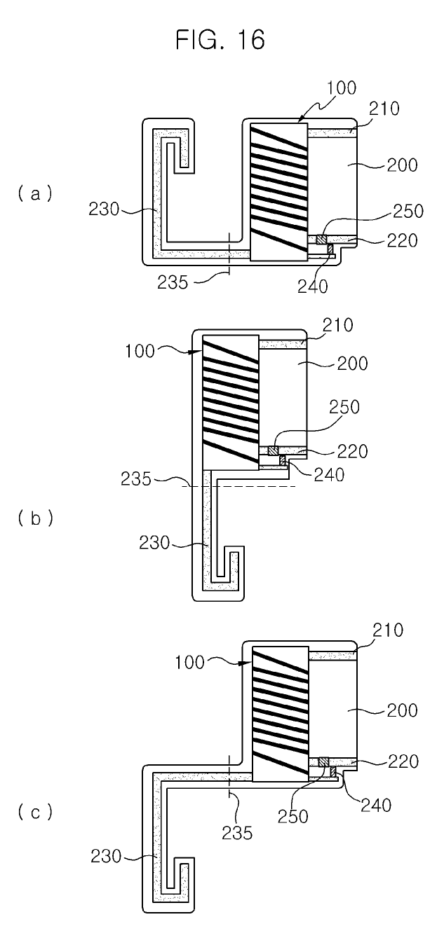

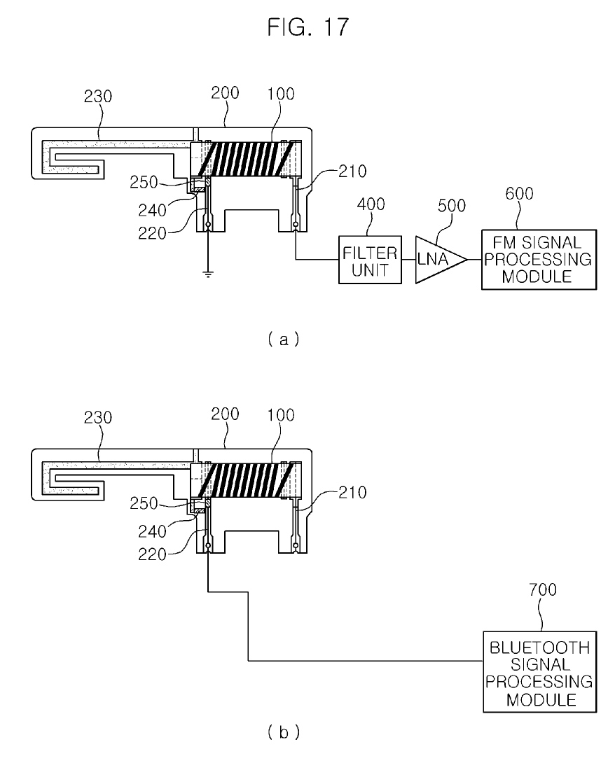

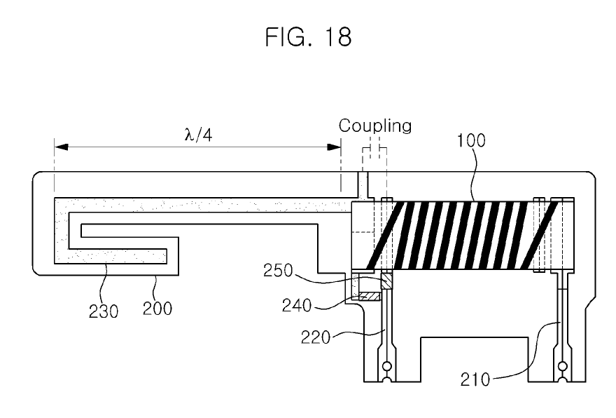

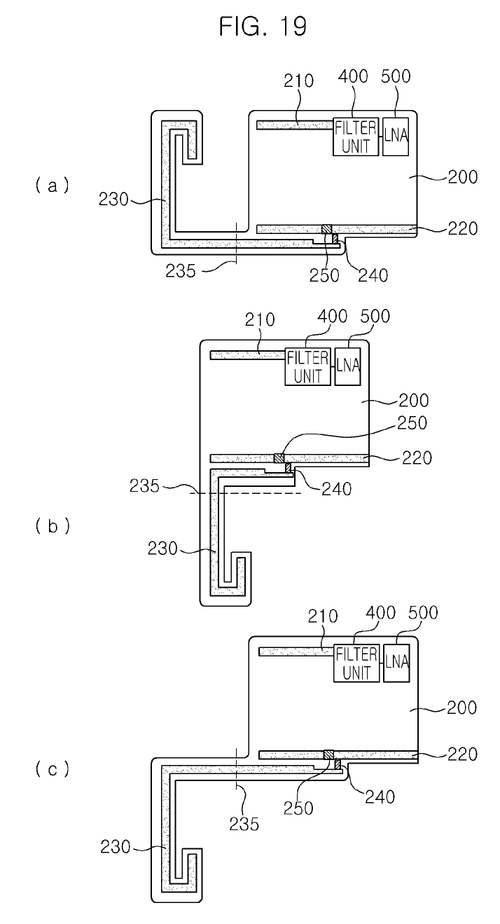

Hereinafter, an internal antenna module according to a fourth embodiment of the present invention will be described in detail with reference to the accompanying drawings. FIG. 14 is a diagram illustrating the internal antenna module according to the fourth embodiment of the present invention. FIGS. 15(a) to 15(c) are plan views illustrating the structure of a flexible circuit board electrically connected to the chip antenna of FIG. 1. FIG. 16 is a plan view illustrating the state in which the chip antenna of FIG. 1 is mounted on the flexible circuit board shown in FIGS. 15(a) to 15(c). FIGS. 17 and 18 are diagrams illustrating a signal switching unit of FIG. 16. FIGS. 19 to 21 are diagrams illustrating a filter unit and an LNA of FIG. 16. First, since the chip antenna of the internal antenna module according to the fourth embodiment of the present invention is the same as the chip antenna described with reference to FIGS. 1 and 2, a description thereof will be omitted here and the same reference numerals will be assigned. Furthermore, since an FM signal processing module and a Bluetooth signal processing module are technical elements that may be easily implemented by a person having ordinary skill in the art using the known art, detailed descriptions thereof will be omitted here.

As shown in FIG. 14, the internal antenna module includes a chip antenna 100, a flexible circuit board 200, a signal switching unit 300, a filter unit 400, and an LNA 500.

The chip antenna 100 is mounted on any one face (e.g., a top surface of the flexible circuit board 200) of the flexible circuit board 200.

The flexible circuit board 200 includes a first conductive pad 210, a second conductive pad 220, a second radiant pattern 230, a matching capacitor 240, and a matching inductor 250, as shown in FIG. 15.

The first conductive pad 210 is used as a feeding pad, and is soldered and electrically connected to the first radiant pattern 120 I₁ formed at the end of one side of the bottom 110b of the polyhedral block 110.

The second conductive pad 220 is used as a ground pad. The second conductive pad 220 is soldered and electrically connected to the coupling pattern 125 formed on the bottom 110b of the polyhedral block 110.

The second radiant pattern 230 is formed in a specific meander line form (e.g., a “ [symbol] ” form), and is soldered and electrically connected to the first radiant pattern 120 Iₖ₊₁ formed at the end of the other side of the bottom 110b of the polyhedral block 110. For this purpose, the second radiant pattern 230 includes a connection part connected to the first radiant pattern 120 Iₖ₊₁ and a radiation part configured to extend from the connection part and formed outside an area on which the polyhedral block 110 is mounted on the flexible circuit board 200. Here, the radiation part of the second radiant pattern 230 is formed in a meander line form, and the radiation part and the connection part may be distinguished from each other based on a bent part 235. That is, a part that is soldered to the first radiant pattern 120 Iₖ₊₁ based on the bent part 235 of the second radiant pattern 230 corresponds to the connection part, and a part that extends from the connection part and is formed outside the area on which the polyhedral block 110 is mounted on the flexible circuit board 200 corresponds to the radiation part in a meander line form. This will be applies to the following drawings in the same manner. Since the second radiant pattern 230 is formed in a meander line form as described above, the area of the flexible circuit board 200 can be reduced, and a mobile communication terminal to which the internal antenna module of the present invention is applied can be reduced in size and can be made slim.

When the second radiant pattern 230 is electrically connected to the first radiant pattern 120 Iₖ₊₁ formed at the end of the other side of the bottom 110b of the polyhedral block 110, the first radiant pattern 120 and the second radiant pattern 230 formed on the flexible circuit board 200 form one radiation line (refer to FIG. 16).

The matching capacitor 240 is formed between the second conductive pad 220 and the second radiant pattern 230, and corrects a difference in impedance between the second conductive pad 220 and a circuit mounted on a substrate on which the flexible circuit board 200 is mounted. That is, the matching capacitor 240 optimizes the antenna characteristics in the Bluetooth frequency band by matching impedance between the internal antenna module and a mobile communication terminal on which the internal antenna module is mounted. Here, a capacitor having a different value according to the state of a mobile communication terminal on which the internal antenna module is mounted is used as the matching capacitor 240. In addition, the matching capacitor 240 may optimize both the antenna characteristics in the Bluetooth frequency band and the antenna characteristics in an FM frequency band.

The matching inductor 250 is formed on the second conductive pad 220, and corrects a difference in impedance between the second conductive pad 220 and the circuit mounted on the substrate on which the flexible circuit board 200 is mounted. That is, the matching inductor 250 optimizes the antenna characteristics in the Bluetooth frequency band by matching impedance between the internal antenna module and a mobile communication terminal on which the internal antenna module is mounted. Here, a capacitor having a different value according to the state of a mobile communication terminal on which the internal antenna module is mounted is used as the matching inductor 250. In addition, the matching inductor 250 may optimize both the antenna characteristics in the Bluetooth frequency band and the antenna characteristics in an FM frequency band.

One side of the signal switching unit 300 is connected to the second conductive pad 220, and the other side thereof is connected to a ground GND. That is, one side of the signal switching unit 300 is soldered and electrically connected to the second conductive pad 220 of the flexible circuit board 200, and the other side thereof is soldered and electrically connected to the ground GND. Here, the signal switching unit 300 is formed of an inductor for transmitting a reception signal in an FM frequency band, but blocks a reception signal in the Bluetooth frequency band. The purpose of this is to separate the reception signal in an FM frequency band and the reception signal in the Bluetooth frequency band using the characteristics of the inductor which has an impedance that increases when a passing frequency increases and thus operates as an LPF and has an impedance that falls when a passing frequency falls and thus operates as an HPF. Here, the inductor used as the signal switching unit 300 has about 22 nH that transmits the reception signal in an FM frequency band (about 87.5 to 108 MHz) and blocks the reception signal in the Bluetooth frequency band (about 2.45 GHz).

The signal switching unit 300 may sever the connection with the ground GND depending on the frequency of a reception signal received via the chip antenna 100 and the flexible circuit board 200. Here, the signal switching unit 300 maintains the connection with the ground GND when the frequency of the reception signal is a low frequency signal and severs the connection with the ground GND in order to send the reception signal to a Bluetooth signal processing module 700 when the frequency of the reception signal is a high frequency signal. That is, when the reception signal in an FM frequency band (i.e., a low frequency) is received, the signal switching unit 300 plays the role of a line to maintain the connection with the ground GND. When the reception signal in the Bluetooth frequency band (i.e., at a high frequency) is received, the signal switching unit 300 severs the connection with the ground GND in order to prevent the reception signal from being sent to the ground GND.

The signal switching unit 300 formed of the inductor having 22 nH will now be described in more detail. When the reception signal in an FM frequency band (i.e., at a low frequency) is received through the chip antenna 100 and the flexible circuit board 200, the inductor maintains the connection part and the ground GND in a connected state and thus plays the role of a line that transmits the reception signal to the ground GND. Accordingly, the second conductive pad 220 plays the role of a ground, and the internal antenna module operates, as shown in FIG. 17(a).

When the reception signal in the Bluetooth frequency band (i.e., at a high frequency) is received through the chip antenna 100 and the flexible circuit board 200, the inductor is opened so that the reception signal is prevented from being sent to the ground GND. Accordingly, the internal antenna module operates as a circuit, not including the inductor and the ground GND, as shown in FIG. 17(b), and thus operates as a monopole antenna. That is, as shown in FIG. 18, coupling is generated because the second conductive pad 220 is spaced apart from the radiation part of the second radiant pattern 230 by a specific interval. The radiation part plays the role of a λ/4 resonant line in the Bluetooth frequency band and thus operates as a Bluetooth antenna.

Meanwhile, the reception signal in the Bluetooth frequency band blocked by the signal switching unit 300 is input to the Bluetooth signal processing module 700.

The filter unit 400 is provided on the flexible circuit board 200. One side of the filter unit 400 is electrically connected to the first radiant pattern 120 formed on the polyhedral block 110 via the first conductive pad 210, and the other side of the filter unit 400 is electrically connected to the LNA 500. The filter unit 400 removes a high frequency component from the reception signal received via the chip antenna 100 and the flexible circuit board 200. In the case of Bluetooth, a terminal and a Bluetooth device periodically generate a transmission signal in the Bluetooth frequency band for the purpose of communication between the terminal and the Bluetooth device. Accordingly, the reception signal in an FM frequency band may interfere with the transmission signal in the Bluetooth frequency band. The filter unit 400 removes a high frequency component in order to prevent signal interference from being generated in the reception signal due to the transmission signal in the Bluetooth frequency band.

The LNA 500 is provided on the flexible circuit board 200, and is electrically connected to the filter unit 400. The LNA 500 amplifies the reception signal from which the high frequency component has been removed by the filter unit 400 (i.e., the reception signal in an FM frequency band from which signal interference due to the transmission signal in the Bluetooth frequency band has been removed), thereby enabling FM radio to be received at a high RSSI level. The LNA 500 is designed by setting an operating point and a matching point so that the reception signal has a low NF. The reception signal amplified by the LNA 500 is input to the FM signal processing module 600.

Since the LNA 500 applied to the present invention is a technical element that may be implemented by a person having ordinary skill in the art using the known art, a detailed description thereof will be omitted here.

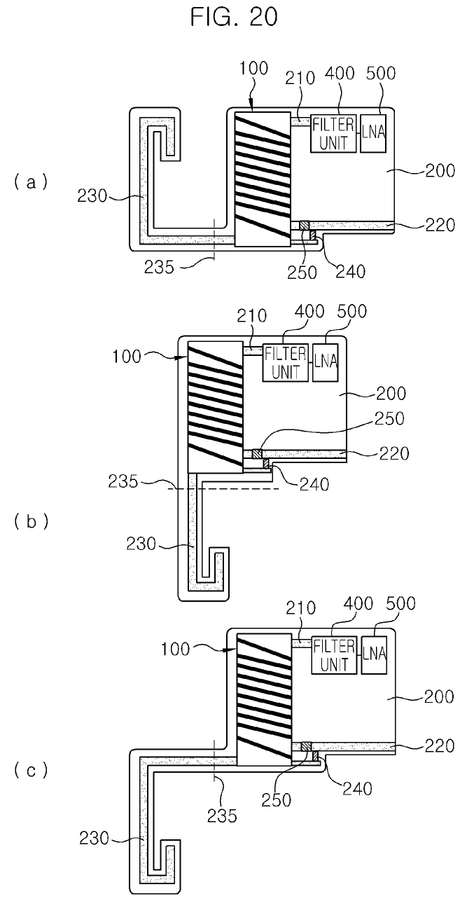

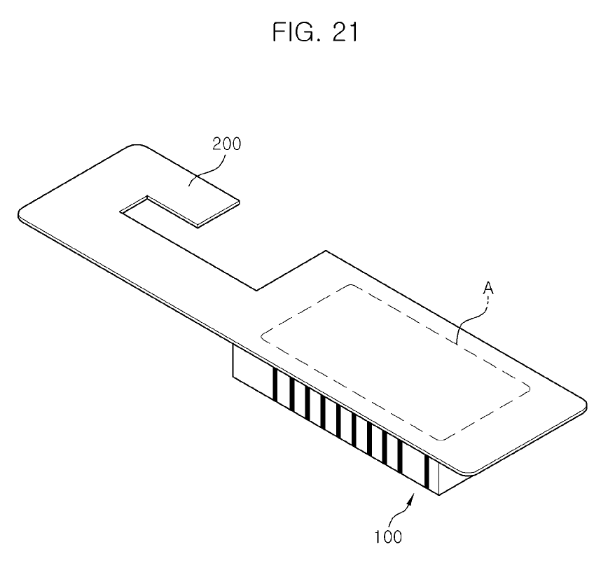

Meanwhile, if the filter unit 400 and the LNA 500 are included in the flexible circuit board 200, they may be included in separate areas on the same plane as the chip antenna 100, as shown in FIGS. 19 and 20, or may be included on the other face (i.e., an area ‘A’ in FIG. 21) opposite to the one face on the flexible circuit board 200 on which the chip antenna 100 is mounted as shown in FIG. 21. The filter unit 400 and the LNA 500 may be included on different faces. In this case, when the internal antenna module according to the present invention is subsequently mounted on a main printed circuit board (not shown), a spatial burden can be reduced and space utilization can be increased. Accordingly, the degree of freedom of a structure in which a part is installed within a terminal can be improved.

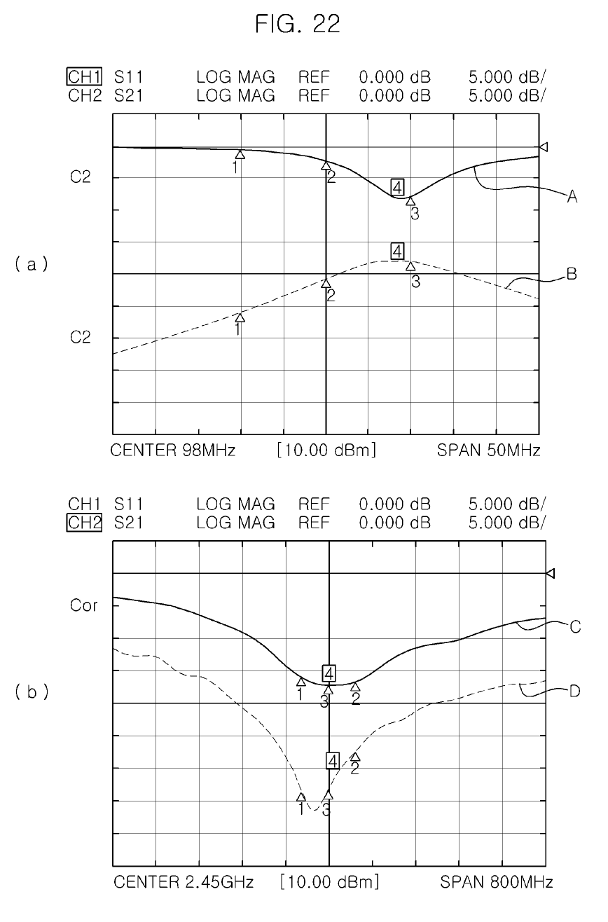

FIG. 22 is a graph showing the frequency bands of the internal antenna module according to the fourth embodiment of the present invention. FIG. 22 is a graph showing the frequencies of reception signals received via the first conductive pad 210 and the second conductive pad 220 and signal interference of the reception signals when the internal antenna module according to the fourth embodiment of the present invention is used.

“A” as shown in FIG. 22(a) is the frequency of a reception signal received via the first conductive pad 210 (i.e., a reception signal received when both the first radiant pattern 120 and the second radiant pattern 230 operate as one antenna (i.e., a reception signal at an FM frequency)). “B” is the degree of isolation between a reception signal received via the second conductive pad 220 (i.e., a reception signal received from the second radiant pattern 230 (i.e., a reception signal of a Bluetooth frequency)) and a reception signal received via the first conductive pad 210.

The frequency of the reception signal (i.e., “A” in FIG. 22(a)) received via the first conductive pad 210 shows that it has a resonant frequency band of about 87.5 MHz to 108 MHz. That is, the radiation part formed on the flexible circuit board 200 and the first radiant pattern 120 formed on the chip antenna 100 form one radiation line, thus receiving the reception signal in a low frequency band (i.e., an FM frequency band (87.5 MHz to 108 MHz)).

Here, the degree of isolation (i.e., “B” in FIG. 22(a)) of the reception signal received through the first conductive pad 210 is about 17 dB. It can be seen that the degree of interference of the reception signal received via the second radiant pattern 230, affecting the reception signal received via the first conductive pad 210, is weak

“C” as shown in FIG. 22(b) is the frequency of a reception signal received via the second conductive pad 220 (i.e., a reception signal received from the second radiant pattern 230 (i.e., a reception signal of a Bluetooth frequency)). “D” is the degree of isolation between a reception signal received via the second conductive pad 220 (i.e., a reception signal of a Bluetooth frequency) and a reception signal via the first conductive pad 210 (i.e., a reception signal received when both the first radiant pattern 120 and the second radiant pattern 230 operate as one antenna (i.e., a reception signal of an FM frequency)).

The frequency of the reception signal (i.e., “B” in FIG. 22) received via the second conductive pad 220 shows that a resonant frequency band is about 2.4 GHz. That is, coupling is generated because the second conductive pad 220 is adjacent to the radiation part in a meander line form. The radiation part in a meander line form plays the role of a λ/4 resonant line in the Bluetooth frequency band. Accordingly, the internal antenna module operates as a monopole antenna using coupling, thus receiving a reception signal having a frequency in the Bluetooth frequency band.

Here, the degree of isolation (i.e., “D” in FIG. 22(b)) of the reception signal received via the second conductive pad 220 is about 32.6 dB. It can be seen that the degree of interference of the reception signal received via the first conductive pad 210, affecting the reception signal received via the second conductive pad 220, is weak

### Fifth Embodiment

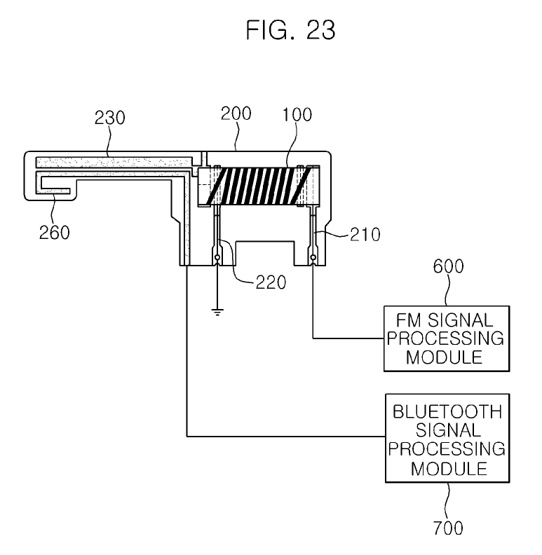

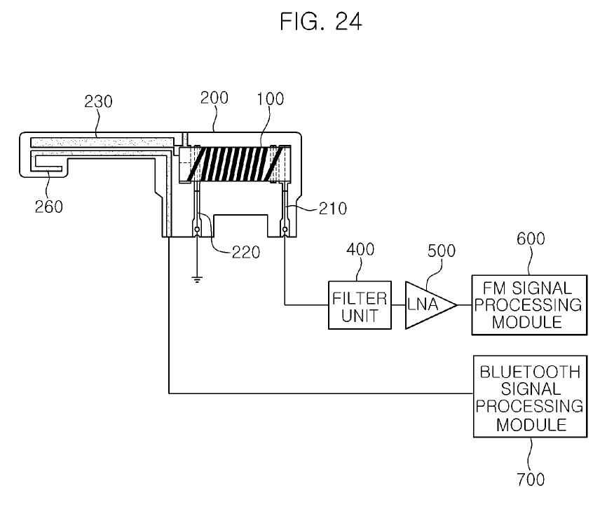

Hereinafter, an internal antenna module according to a fifth embodiment of the present invention will be described in more detail with reference to the accompanying drawings FIGS. 23 and 24 are diagrams illustrating the internal antenna module according to the fifth embodiment of the present invention. First, since the chip antenna of the internal antenna module according to the fifth embodiment of the present invention is the same as the chip antenna described with reference to FIGS. 1 and 2, descriptions thereof will be omitted here and the same reference numerals will be assigned. Furthermore, since an FM signal processing module 600 and a Bluetooth signal processing module 700 are technical elements that may be easily implemented by a person having ordinary skill in the art using the known art, a detailed description thereof will be omitted here.

As shown in FIG. 23, the internal antenna module includes a chip antenna 100, and a flexible circuit board 200.

The chip antenna 100 is mounted on any one face (e.g., a top surface of the flexible circuit board 200) of the flexible circuit board 200.

The flexible circuit board 200 includes a first conductive pad 210, a second conductive pad 220, and a second radiant pattern 230, and a third radiant pattern 260.

The first conductive pad 210 is used as a feeding pad, and is soldered and electrically connected to the first radiant pattern 120 I₁ formed at the end of one side of the bottom 110b of the polyhedral block 110. Here, one side of the first conductive pad 210 is electrically connected to an FM signal processing module 600, and sends an signal in the FM frequency band, received via the chip antenna 100 and the flexible circuit board 200, to the FM signal processing module 600.

The second conductive pad 220 is used as a ground pad. The second conductive pad 220 is soldered and electrically connected to the coupling pattern 125 formed on the bottom 110b of the polyhedral block 110. Here, one side of the second conductive pad 220 is electrically connected to a ground GND.

The second radiant pattern 230 is formed in a specific meander line form (e.g., a “ [symbol] ” form), and is soldered and electrically connected to the first radiant pattern 120 Iₖ₊₁ formed at the end of the other side of the bottom 110b of the polyhedral block 110. For this purpose, the second radiant pattern 230 includes a connection part connected to the first radiant pattern 120 Iₖ₊₁ and a radiation part configured to extend from the connection part and formed outside an area on which the polyhedral block 110 is mounted on the flexible circuit board 200. Here, the radiation part of the second radiant pattern 230 is formed in a meander line form, and the radiation part and the connection part may be distinguished from each other based on the bent part 235. That is, a part soldered to the first radiant pattern 120 Iₖ₊₁ based on the bent part 235 of the second radiant pattern 230 corresponds to the connection part, and a part configured to extend from the connection part and formed outside the area on which the polyhedral block 110 is mounted on the flexible circuit board 200 corresponds to the radiation part in a meander line form. This will be applied to the following drawings in the same manner.

When the second radiant pattern 230 is electrically connected to the first radiant pattern 120 Iₖ₊₁ formed at the end of the other side of the bottom 110b of the polyhedral block 110, the first radiant pattern 120 and the second radiant pattern 230 formed on the flexible circuit board 200 form one radiation line.

The third radiant pattern 260 is spaced apart from the second radiant pattern 230 by a specific interval. The third radiant pattern 260 is formed in parallel to the second radiant pattern 230 and formed in a specific meander line form (e.g., a form in which “ [symbol] ” and “ [symbol] ” are combined). The third radiant pattern 260 is formed outside the area on which the polyhedral block 110 is mounted on the flexible circuit board 200. One side of the third radiant pattern 260 is electrically connected to a Bluetooth signal processing module 700. The third radiant pattern 260 operates as a Bluetooth antenna that receives a signal in the Bluetooth frequency band and sends the signal to the Bluetooth signal processing module 700.

As shown in FIG. 24, the internal antenna module may further include a filter unit 400 and an LNA 500.

The filter unit 400 is provided on the flexible circuit board 200. One side of the filter unit 400 is electrically connected to the first radiant pattern 120 formed on the polyhedral block 110 via the first conductive pad 210, and the other side thereof is electrically connected to the LNA 500. The filter unit 400 removes a high frequency component from a reception signal received via the chip antenna 100 and the flexible circuit board 200. In the case of Bluetooth, a terminal and a Bluetooth device periodically generate a transmission signal in the Bluetooth frequency band for the purpose of communication between the terminal and the Bluetooth device. Accordingly, the reception signal in the FM frequency band may interfere with the transmission signal in the Bluetooth frequency band. The filter unit 400 removes the high frequency component in order to prevent signal interference from being generated in the reception signal due to the transmission signal in the Bluetooth frequency band.

The LNA 500 is provided on the flexible circuit board 200, and is electrically connected to the filter unit 400. The LNA 500 amplifies the reception signal from which the high frequency component has been removed by the filter unit 400 (i.e., the reception signal in an FM frequency band from which signal interference due to the transmission signal in the Bluetooth frequency band has been removed), thereby enabling FM radio to be received at a high RSSI level. The LNA 500 is designed by setting an operating point and a matching point so that the reception signal has a low Noise Factor (NF). The reception signal amplified by the LNA 500 is input into the FM signal processing module 600.

Since the LNA 500 applied to the present invention is a technical element that may be implemented by a person having ordinary skill in the art using the known art a detailed description thereof will be omitted here.

### MODIFIED EXAMPLE OF FIFTH EMBODIMENT

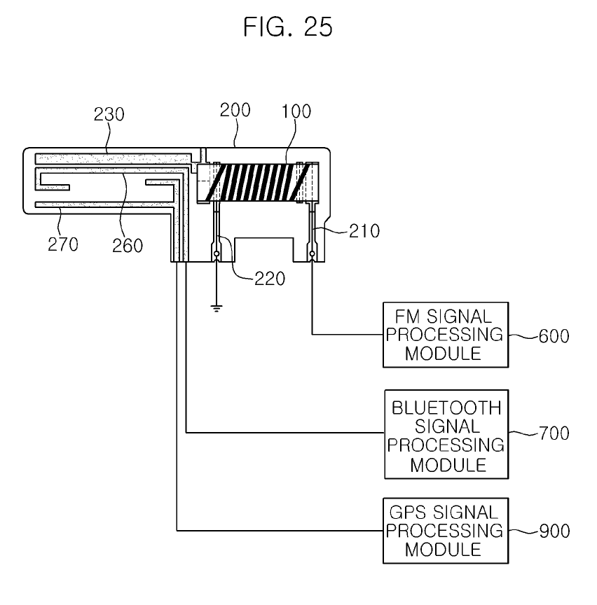

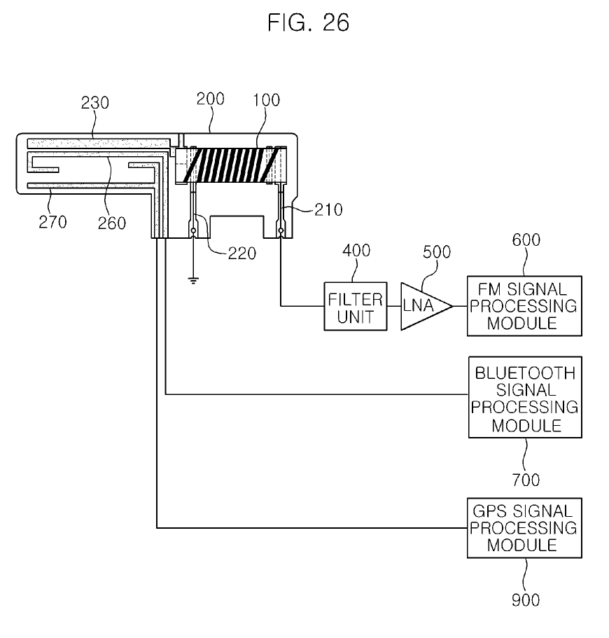

Hereinafter, an internal antenna module according to the modified example of the fifth embodiment of the present invention will be described in detail with reference to the accompanying drawings. FIGS. 25 and 26 are diagrams illustrating the internal antenna module according to the modified example of the fifth embodiment of the present invention. First, since the chip antenna of the internal antenna module according to the modified example of the fifth embodiment of the present invention is the same as the chip antenna described with reference to FIGS. 1 and 2, a description thereof will be omitted here and the same reference numerals will be assigned. Furthermore, since an FM signal processing module 600, a Bluetooth signal processing module 700, and a GPS signal processing module 900 are technical elements that may be easily implemented by a person having ordinary skill in the art using the known art, detailed descriptions thereof will be omitted here.

As shown in FIG. 25, the internal antenna module includes a chip antenna 100 and a flexible circuit board 200. As shown in FIG. 26, the internal antenna module may further include a filter unit 400 and an LNA 500. Here, since the filter unit 400 and the LNA 500 are the same as those of the fifth embodiment, detailed descriptions thereof will be omitted here.

The chip antenna 100 is mounted on any one face (e.g., a top surface of the flexible circuit board 200) of the flexible circuit board 200.

The flexible circuit board 200 includes a first conductive pad 210, a second conductive pad 220, a second radiant pattern 230, a third radiant pattern 260, and a fourth radiant pattern 270. Since the first conductive pad 210, the second conductive pad 220, the second radiant pattern 230, and the third radiant pattern 260 are the same as those of the fifth embodiment, detailed descriptions thereof will be omitted here.

The fourth radiant pattern 270 is spaced apart from the third radiant pattern 260 by a specific interval. The fourth radiant pattern 270 is formed in parallel to the third radiant pattern 260 and formed in a specific meander line form (e.g., a “ [symbol] ” form). Here, the fourth radiant pattern 270 is formed outside the area on which the polyhedral block 110 is mounted on the flexible circuit board 200. One side of the fourth radiant pattern 270 is electrically connected to the GPS signal processing module 900. The fourth radiant pattern 270 operates as a GPS antenna that receives a signal of a GPS frequency band and sends the signal to the GPS signal processing module 900.

The internal antenna module according to the modified example of the fifth embodiment of the present invention receives signals in the FM frequency, the Bluetooth frequency, and the GPS frequency, and therefore it does not require additional Bluetooth and GPS antennas. Accordingly, it is possible to apply the internal antenna module of the present embodiment to a mobile communication terminal, thereby reducing the size and width of the mobile communication terminal.

### Sixth Embodiment

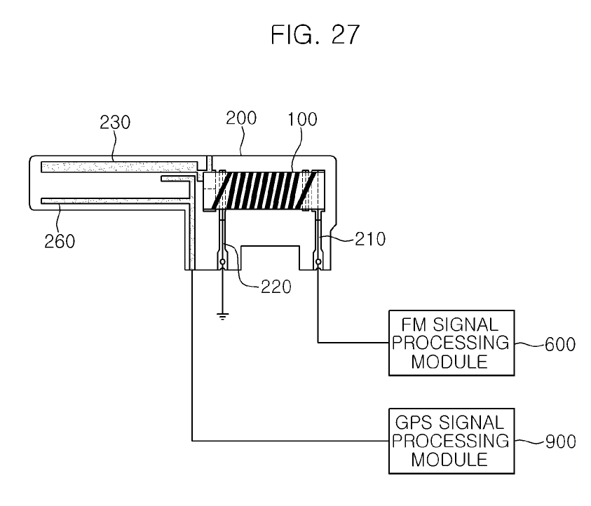

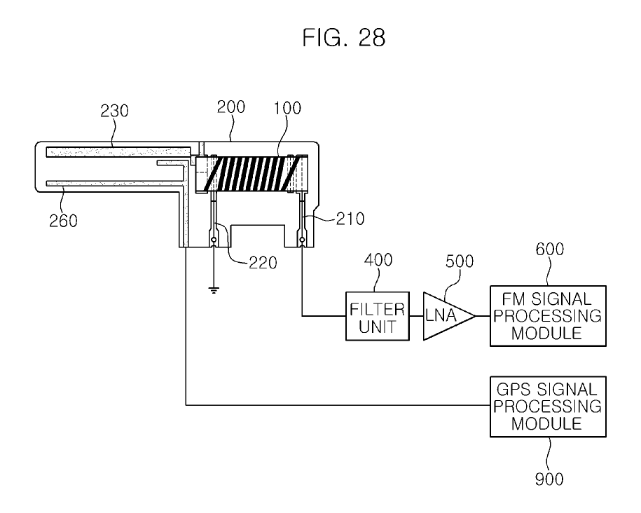

Hereinafter, an internal antenna module according to a sixth embodiment of the present invention will be described in detail with reference to the accompanying drawings. FIGS. 27 and 28 are diagrams illustrating the internal antenna module according to the sixth embodiment of the present invention. First, since the chip antenna of the internal antenna module according to the sixth embodiment of the present invention is the same as the chip antenna described with reference to FIGS. 1 and 2, a description thereof will be omitted here and the same reference numeral will be assigned. Furthermore, since an FM signal processing module 600 and a GPS signal processing module 700 are technical elements that may be easily implemented by a person having ordinary skill in the art using the known art, a detailed description thereof will be omitted here.

As shown in FIG. 27, the internal antenna module includes a chip antenna 100 and a flexible circuit board 200.

The chip antenna 100 is mounted on any one face (e.g., a top surface of the flexible circuit board 200) of the flexible circuit board 200.

The flexible circuit board 200 includes a first conductive pad 210, a second conductive pad 220, and a second radiant pattern 230, and a third radiant pattern 260.

The first conductive pad 210 is used as a feeding pad, and is soldered and electrically connected to the first radiant pattern 120 I₁ formed at the end of one side of the bottom 110b of the polyhedral block 110. Here, one side of the first conductive pad 210 is electrically connected to an FM signal processing module 600, and sends an FM frequency band signal, received via the chip antenna 100 and the flexible circuit board 200, to the FM signal processing module 600.

The second conductive pad 220 is used as a ground pad. The second conductive pad 220 is soldered and electrically connected to the coupling pattern 125 formed on the bottom 110b of the polyhedral block 110. Here, one side of the second conductive pad 220 is electrically connected to a ground GND.

The second radiant pattern 230 is formed in a specific meander line form (e.g., a “ [symbol] ” form), and is soldered and electrically connected to the first radiant pattern 120 Iₖ₊₁ formed at the end of the other side of the bottom 110b of the polyhedral block 110. For this purpose, the second radiant pattern 230 includes a connection part connected to the first radiant pattern 120 Iₖ₊₁ and a radiation part configured to extend from the connection part and formed outside an area on which the polyhedral block 110 is mounted on the flexible circuit board 200. Here, the radiation part of the second radiant pattern 230 is formed in a meander line form, and the radiation part and the connection part may be distinguished from each other based on the bent part 235. That is, a part soldered to the first radiant pattern 120 Iₖ₊₁ based on the bent part 235 of the second radiant pattern 230 corresponds to the connection part, and a part extended from the connection part and formed outside the area on which the polyhedral block 110 is mounted on the flexible circuit board 200 corresponds to the radiation part in a meander line form. The same principle applies to the following drawings.

When the second radiant pattern 230 is electrically connected to the first radiant pattern 120 Iₖ₊₁ formed at the end of the other side of the bottom 110b of the polyhedral block 110, the first radiant pattern 120 and the second radiant pattern 230 formed on the flexible circuit board 200 form one radiation line.

The third radiant pattern 260 is spaced apart from the second radiant pattern 230 by a specific interval. The third radiant pattern 260 is formed in parallel to the second radiant pattern 230, and is formed in a specific meander line form (e.g., a “ [symbol] ” form). The third radiant pattern 260 is formed outside the area on which the polyhedral block 110 is mounted on the flexible circuit board 200. One side of the third radiant pattern 260 is electrically connected to a GPS signal processing module 900. The third radiant pattern 260 operates as a GPS antenna for receiving a signal of a GPS frequency band and sending the signal to the GPS signal processing module 900.

As shown in FIG. 28, the internal antenna module may further include a filter unit 400 and an LNA 500. Here, the filter unit 400 and the LNA 500 are the same as those of the fifth embodiment, and a detailed description thereof will be omitted here.

### MODIFIED EXAMPLE OF THE SIXTH EMBODIMENT

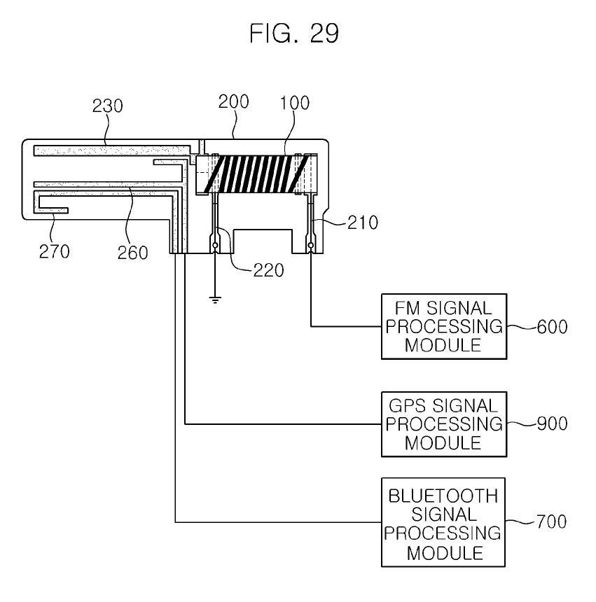

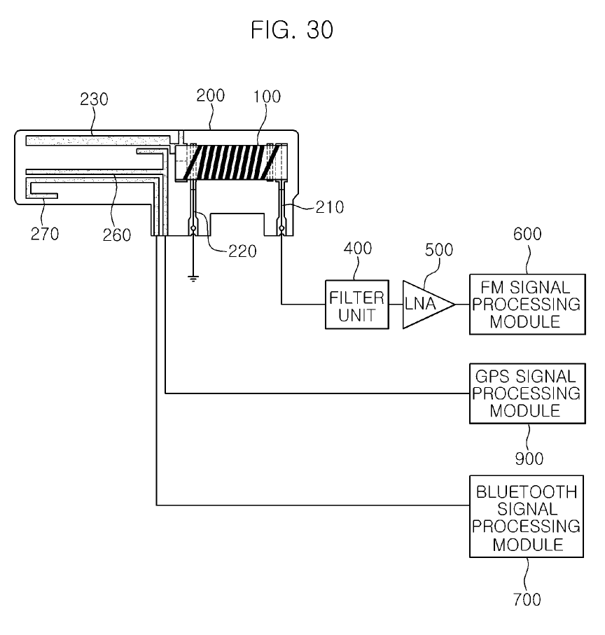

Hereinafter, an internal antenna module according to a modified example of the sixth embodiment of the present invention will be described in detail with reference to the accompanying drawings. FIGS. 29 and 30 are diagrams illustrating the internal antenna module according to the modified example of the sixth embodiment of the present invention. First, since the chip antenna of the internal antenna module according to the modification of the sixth embodiment of the present invention is the same as the chip antenna described with reference to FIGS. 1 and 2, a description thereof will be omitted here and the same reference numerals will be assigned. Furthermore, since an FM signal processing module 600, a Bluetooth signal processing module 700, and a GPS signal processing module 900 are technical elements that may be easily implemented by a person having ordinary skill in the art using the known art, detailed descriptions thereof will be omitted here.

As shown in FIG. 29, the internal antenna module includes a chip antenna 100 and a flexible circuit board 200. As shown in FIG. 30, the internal antenna module may further include a filter unit 400 and an LNA 500. Here, since the filter unit 400 and the LNA 500 are the same as those of the sixth embodiment, detailed descriptions thereof will be omitted here.

The chip antenna 100 is mounted on any one face (e.g., a top surface of the flexible circuit board 200) of the flexible circuit board 200.

The flexible circuit board 200 includes a first conductive pad 210, a second conductive pad 220, a second radiant pattern 230, a third radiant pattern 260, and a fourth radiant pattern 270. Here, since the first conductive pad 210, the second conductive pad 220, the second radiant pattern 230, and the third radiant pattern 260 are the same as those of the sixth embodiment, detailed descriptions thereof will be omitted here.

The fourth radiant pattern 270 is spaced apart from the third radiant pattern 260 by a specific interval. The fourth radiant pattern 270 is formed in parallel to the third radiant pattern 260, and is formed in a specific meander line form (e.g., a form in which “ [symbol] ” and “ [symbol] ” are combined). The fourth radiant pattern 270 is formed outside an area on which the polyhedral block 110 is mounted on the flexible circuit board 200. One side of the fourth radiant pattern 270 is electrically connected to the Bluetooth signal processing module 700. The fourth radiant pattern 270 operates as a Bluetooth antenna that receives a signal in the Bluetooth frequency band and sends the signal to the Bluetooth signal processing module 700.

The internal antenna module according to the modified example of the sixth embodiment of the present invention receives signals at FM, Bluetooth and GPS frequencies, and therefore it does not require an additional Bluetooth antenna and an additional GPS antenna. Accordingly, it is possible to apply the internal antenna module of the present embodiment to a mobile communication terminal, thereby reducing the size and width of the mobile communication terminal.

### Seventh Embodiment

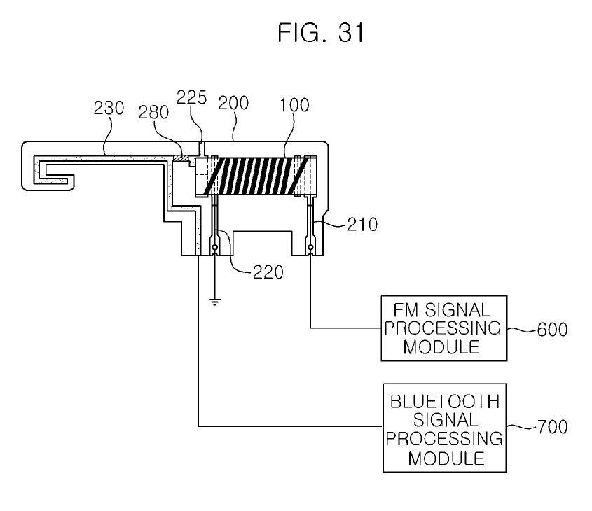

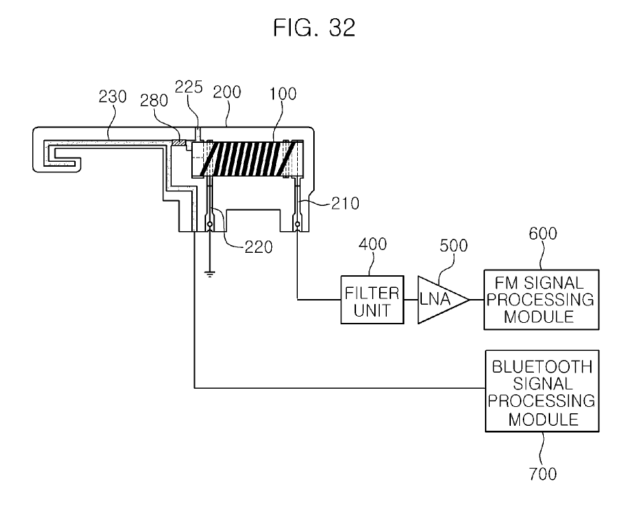

Hereinafter, an internal antenna module according to a seventh embodiment of the present invention will be described in detail with reference to the accompanying drawings. FIGS. 31 and 32 are diagrams illustrating the internal antenna module according to the seventh embodiment of the present invention. First, since the chip antenna of the internal antenna module according to the seventh embodiment of the present invention is the same as the chip antenna described with reference to FIGS. 1 and 2, a description thereof will be omitted here and the same reference numerals will be assigned. Furthermore, since an FM signal processing module 600 and a Bluetooth signal processing module 700 are technical elements that may be easily implemented by a person having ordinary skill in the art using the known art, detailed descriptions thereof will be omitted here.

As shown in FIG. 31, the internal antenna module includes a chip antenna 100 and a flexible circuit board 200. As shown in FIG. 32, the internal antenna module may further include a filter unit 400 and an LNA 500. Here, since the filter unit 400 and the LNA 500 are the same as those of the sixth embodiment, detailed descriptions thereof will be omitted here.

The chip antenna 100 is mounted on any one face (e.g., a top surface of the flexible circuit board 200) of the flexible circuit board 200.

The flexible circuit board 200 includes a first conductive pad 210, a second conductive pad 220, a connection pad 225, a second radiant pattern 230, and a switching element 280. Here, since the first conductive pad 210 and the second conductive pad 220 are the same as those of the fourth embodiment, detailed descriptions thereof will be omitted here.

The connection pad 225 is soldered and electrically connected to the first radiant pattern 120 Iₖ₊₁ formed on the bottom of the polyhedral block Here, the connection pad 225 is electrically connected to the second radiant pattern 230 via the switching element 280.

The second radiant pattern 230 is formed in a specific meander line form (e.g., a form in which “ [symbol] ” and a bent “1” are combined). One side of the second radiant pattern 230 is electrically connected to the Bluetooth signal processing module 700. Here, the second radiant pattern 230 is connected to the connection pad 225, connected to the first radiant pattern 120 Iₖ₊₁, via the switching element 280. When the second radiant pattern 230 is electrically connected to the first radiant pattern 120 Iₖ₊₁ formed at the end of the other side of the bottom 110b of the polyhedral block 110 via the switching element 280, the first radiant pattern 120 and the second radiant pattern 230 formed on the flexible circuit board 200 form one radiation line.

The switching element 280 is formed on the flexible circuit board 200. One side of the switching element 280 is connected to the connection pad 225, and the other side thereof is connected to the second radiant pattern 230. That is, one side of the switching element 280 is soldered and electrically connected to the connection pad 225, and the other side thereof is soldered and electrically connected to the second conductive pad 220. The switching element 280 is formed of an inductor that transmits a reception signal in an FM frequency band and blocks a reception signal of a Bluetooth band. The purpose of this is to separate the reception signal in an FM frequency band and the reception signal in the Bluetooth band using the characteristics of the inductor which has an impedance that increases when a passing frequency increases and thus operates as an LPF and has an impedance that falls when a passing frequency falls and thus operates as an HPF. The inductor used as the switching element 280 has about 22 nH that transmits a reception signal in an FM frequency band (about 87.5 to 108 MHz) and blocks a reception signal of a Bluetooth band (about 2.45 GHz).

The switching element 280 severs the connection with the connection pad 225 depending on the frequency of a reception signal received via the second radiant pattern 230.

Here, the switching element 280 maintains the connection with the connection pad 225 when the frequency of the reception signal is a low frequency and severs the connection with the connection pad 225 when the frequency of the reception signal is a high frequency so that the second radiant pattern 230 operates as a monopole antenna. That is, when a reception signal in the FM frequency band (i.e., at a low frequency) is received, the switching element 280 maintains the connection with the connection pad 225 so that the first radiant pattern and the second radiant pattern 230 play the role of one radiation line. When a reception signal in the Bluetooth frequency band (i.e., at a high frequency) is received, the switching element 280 severs the connection with the connection pad 225 so that the second radiant pattern 230 plays the role of a monopole antenna for receiving the Bluetooth frequency band signal.

The switching element 280 formed of the inductor having 22 nH will now be described in more detail. When a reception signal in the FM frequency band (i.e., a low frequency) is received via the second radiant pattern 230, the inductor maintains the connection pad 225 and the second radiant pattern 230 in a connected state and thus plays the role of a line that transmits the reception signal to the first radiant pattern. When a reception signal in the Bluetooth frequency band (i.e., at a high frequency) is received via the second radiant pattern 230, the inductor is opened, so that the reception signal is prevented from reaching the first radiant pattern via the connection pad 225. Accordingly, the second radiant pattern 230 operates as a Bluetooth antenna.

Meanwhile, the reception signal in the Bluetooth frequency band blocked by the switching element 280 is input to the Bluetooth signal processing module 700.

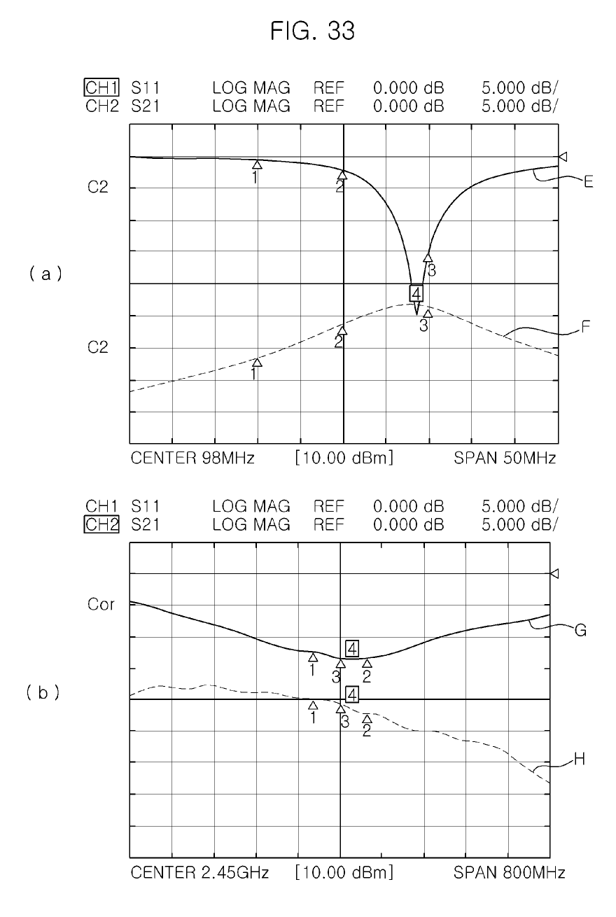

FIG. 33 is a graph showing the frequency bands of the internal antenna module according to the seventh embodiment of the present invention. FIG. 33 is a graph showing the frequencies of reception signals received via the first conductive pad 210 and the second conductive pad 220 and the signal interference of the reception signals when the internal antenna module according to the seventh embodiment of the present invention is used.

“E” as shown in FIG. 33(a) is the frequency of the reception signal received through the first conductive pad 210, and “F′ is the degree of isolation of the reception signal received through the first conductive pad 210 and the reception signal received through the second conductive pad 220.

The frequency of the reception signal (i.e., “E” in FIG. 29(a)) received through the first conductive pad 210 shows that the resonant frequency band is about 87.5 MHz to 108 MHz. That is, the second radiant pattern 230 formed on the flexible circuit board 200 and the first radiant pattern 120 formed on the chip antenna 100 form one radiation line via the connection pad 225 and thus receive the reception signal in the low frequency band (i.e., the FM frequency band (87.5 MHz to 108 MHz)).

Here, the degree of isolation of the reception signal (i.e., “F′ in FIG. 29(a)) received through the first conductive pad 210 is about 23.3 dB. It can be seen that the degree of interference of the reception signal received through the second conductive pad 220, affecting the reception signal received through the first conductive pad 210, is weak

In FIG. 33(b), “G” is the frequency of the reception signal received through the second conductive pad 220, and “H” is the degree of isolation of the reception signal received through the second conductive pad 220 and the reception signal received through the first conductive pad 210.

The frequency of the reception signal (i.e., “G” in FIG. 29(b)) received through the second conductive pad 220 shows that a resonant frequency band is about 2.4 GHz. That is, the second conductive pad 220 plays the role of a λ/4 resonant line in the Bluetooth frequency band, and receives a reception signal having the frequency in the Bluetooth frequency band.

Here, the degree of isolation of the reception signal (i.e., “H” in FIG. 29(b)) received through the second conductive pad 220 is about 21.3 dB. It can be seen that the degree of interference of the reception signal received through the first conductive pad 210, affecting the reception signal received through the second conductive pad 220, is weak.

Although in the embodiments of the present invention, the filter unit 400 and the LNA 500 are illustrated as being mounted on the flexible circuit board 200, the present invention is not limited thereto. For example, the filter unit 400 and the LNA 500 may be integrated with the FM signal processing module, and may process relevant functions.

Although the preferred embodiments of the present invention have been described, it will be appreciated by those skilled in the art will appreciate that various variations and modifications are possible without departing from the scope of the invention as disclosed in the accompanying claims.

1. An internal antenna module, comprising:
a polyhedral chip antenna configured to have a first radiant pattern and a coupling pattern formed thereon;
a flexible circuit board configured to have a first conductive pad connected to the first radiant pattern, a second conductive pad connected to the coupling pattern, and a second radiant pattern connected to the first radiant pattern; and
a signal switching unit formed between the second conductive pad and a ground, and configured to prevent any one of a first frequency signal band and a second frequency band signal, received through the chip antenna and the flexible circuit board, from reaching the ground.

2. The internal antenna module as set forth in claim 1, wherein the signal switching unit prevents the second frequency band signal from reaching the ground, and sends the second frequency band signal to a Bluetooth signal processing module.

3. The internal antenna module as set forth in claim 1, wherein the signal switching unit is formed of an inductor that prevents a Bluetooth frequency band signal from reaching the ground.

4. The internal antenna module as set forth in claim 1, wherein:
the first frequency band signal is an FM frequency band signal, and
the second frequency band signal is a Bluetooth frequency band signal.

5. The internal antenna module as set forth in claim 4, further comprising a filter unit for removing a high frequency component from the first frequency band signal.

6. The internal antenna module as set forth in claim 5, further comprising a Low Noise Amplifier (LNA) for amplifying the first frequency band signal from which the high frequency component has been removed by the filter unit

7. The internal antenna module as set forth in claim 1, wherein the second radiant pattern is formed in a meander line form.

8. The internal antenna module as set forth in claim 1, further comprising a matching capacitor formed between the second conductive pad and the second radiant pattern and configured to correct a difference in impedance between the second conductive pad and a circuit mounted on a substrate on which the flexible circuit board is mounted.

9. The internal antenna module as set forth in claim 1, further comprising a matching inductor formed on the second conductive pad and configured to correct a difference in impedance between the second conductive pad and a circuit mounted on a substrate on which the flexible circuit board is mounted.

10. An internal antenna module, comprising:
a polyhedral chip antenna configured to have a first radiant pattern and a coupling pattern formed therein;
a flexible circuit board configured to have a first conductive pad connected to the first radiant pattern, a second conductive pad connected to the coupling pattern, and a second radiant pattern connected to the first radiant pattern; and
a signal branch unit configured to branch a first frequency band signal and a second frequency band signal received through the chip antenna and the flexible circuit board.

11. The internal antenna module as set forth in claim 10, wherein the signal branch unit separates the first frequency band signal off into an FM signal processing module and separates the second frequency band signal off into a Bluetooth signal processing module.

12. The internal antenna module as set forth in claim 10, further comprising an LNA for amplifying the first frequency band signal separated off by the signal branch unit

13. The internal antenna module as set forth in claim 10, wherein the signal branch unit is formed of a diplexer for separating an FM frequency band signal off into an FM signal processing module and a Bluetooth frequency band signal off into a Bluetooth signal processing module.

14. An internal antenna module, comprising:
a polyhedral chip antenna configured to have a first radiant pattern and a coupling pattern formed therein;
a flexible circuit board configured to have a first conductive pad connected to the first radiant pattern, a second conductive pad connected to the coupling pattern, and a second radiant pattern connected to the first radiant pattern; and
a third radiant pattern formed adjacent to the second radiant pattern on the flexible circuit board.

15. The internal antenna module as set forth in claim 14, wherein the third radiant pattern is electrically connected to a Bluetooth signal processing module.

16. The internal antenna module as set forth in claim 15, further comprising a fourth radiant pattern formed adjacent to the third radiant pattern on the flexible circuit board, wherein the fourth radiant pattern is electrically connected to a GPS signal processing module.

17. The internal antenna module as set forth in claim 14, wherein the third radiant pattern is electrically connected to a GPS signal processing module.

18. The internal antenna module as set forth in claim 17, further comprising a fourth radiant pattern formed adjacent to the third radiant pattern on the flexible circuit board, wherein the fourth radiant pattern is electrically connected to a Bluetooth signal processing module.

19. An internal antenna module, comprising:
a polyhedral chip antenna configured to have a first radiant pattern and a coupling pattern are formed; and
a flexible circuit board in which a first conductive pad connected to the first radiant pattern, a second conductive pad connected to the coupling pattern and a second radiant pattern connected to the first radiant pattern are formed;
wherein the first conductive pad is electrically connected to an FM signal processing module and a Bluetooth signal processing module, and sends reception signals, received through the chip antenna and the flexible circuit board, to the FM signal processing module and the Bluetooth signal processing module.

20. The internal antenna module as set forth in claim 19, further comprising a filter unit for removing a high frequency component from the reception signal sent to the FM signal processing module.

21. The internal antenna module as set forth in claim 20, further comprising an LNA for amplifying the reception signal from which the high frequency component has been removed by the filter unit

22. An internal antenna module, comprising:
a polyhedral chip antenna configured to have a first radiant pattern and a coupling pattern are formed; and
a flexible circuit board in which a first conductive pad connected to the first radiant pattern, a second conductive pad connected to the coupling pattern, and a second radiant pattern adjacent to the second conductive pad are formed;
wherein the flexible circuit board further comprises a switching element formed between the second radiant pattern and the first radiant pattern and prevents any one of a first frequency band signal and a second frequency band signal, received through the second radiant pattern, from reaching the first radiant pattern.

23. The internal antenna module as set forth in claim 22, wherein the switching element blocks the second frequency band signal received through the second radiant pattern, and sends the second frequency band signal to a Bluetooth signal processing module.

24. The internal antenna module as set forth in claim 22, wherein the switching element is formed of an inductor for preventing a Bluetooth frequency band signal from reaching the first radiant pattern.
